(19) United States
(12) Patent Application Publication
(10) Pub. No.: US 2021/0002438 A1
(43) Pub. Date: Jan. 7, 2021

(54) FLEXIBLE PARTICLE-LADEN ELASTOMERIC TEXTILES WITH PENETRATION RESISTANCE

(71) Applicants: Ponnambalam Ravi Selvaganapathy, Dundas (CA); Chan Yu Ching, Ancaster (CA); Kamrul Russel, Hamilton (CA); Syed Naveed Iqbal Haider Rizvi, North York (CA); Dariush Firouzi, Toronto (CA)

(72) Inventors: Ponnambalam Ravi Selvaganapathy, Dundas (CA); Chan Yu Ching, Ancaster (CA); Kamrul Russel, Hamilton (CA); Syed Naveed Iqbal Haider Rizvi, North York (CA); Dariush Firouzi, Toronto (CA)

(21) Appl. No.: 16/503,987

(22) Filed: Jul. 5, 2019

(51) Int. Cl. C08J 5/24; C08L 83/04; C08L 75/04

(52) U.S. Cl. CPC C08J 5/24; C08L 83/04; C08L 75/04; C08J 2383/04; F41H 5/0471; C08J 2323/06; C08L 2207/062; C08L 2207/068; C08L 2205/16; C08J 2375/04

(57) ABSTRACT

Penetration-resistant composites and methods of forming penetration-resistant composites are described herein. The penetration-resistant composites include a woven or non-woven substrate; and an elastomeric binder covering at least a portion of the substrate. The elastomeric binder includes a polymeric base and particles dispersed within the polymeric base. The particles include one or more of amorphous silica particles, fumed silica particles, boron nitride particles, calcium chloride particles, aluminum oxide particles, calcium carbonate particles, graphite particles, metallic glass particles and silicon carbide particles. The particles have a concentration in a range of about 0 wt. % to about 80 wt. % of the elastomeric binder and have a size in a range of about 1 nanometers to 100 micrometers.

### TECHNICAL FIELD

The following relates to flexible textiles with penetration resistance and more specifically to flexible particle-laden elastomeric textiles with penetration resistance.

### BACKGROUND

Needle stick injuries and other wounds caused due to penetration of sharp objects into the skin are a common form of workplace injuries. Similarly, materials and fabrics that are resistant to penetration of projectiles such as bullets and cuts from objects such as knives and shrapnel are of interest in a number of occupations including law enforcement, waste processing, and military combat. For instance, there is a growing demand for clothing that provides protection against stab threats in law enforcement and for gloves and arm-guards for personnel in recycling and hospital waste removal companies for protection against accidental needle-puncture.

Stab threats are categorized into two classes: puncture penetration by a sharp tip and cutting with a continuous sharp cutting edge. It is generally more difficult to make a resistant textile-armour to cutting as compared to puncture threats. Hypodermic needles, with a thin sharp tip and sloped cutting edges, belong to both categories. In general, protection against hypodermic needle puncture is provided by high thread-count fabrics due to their resistance to “windowing effect”. The “windowing” mechanism occurs when fibers are easily spread-apart and pushed-away by a sharp-tip penetrator without cutting the fabric. In general, areal density of fabric, yarn linear density and mechanical properties of fiber, number of filaments per yarn, fabric weave architecture, and the number of fabric plies affect the penetration resistance of the fabric target. Additionally, the boundary condition of fabric, geometry, type, mass, the speed of penetrator, and inter-yarn and fabric-projectile friction are among the other important factors which could affect the penetration resistance of multilayer textile structures against different types of penetrators.

There has been significant improvement in the manufacture of penetration-resistant materials in recent years. There is, however, still a strong need to improve the performance of protective clothing, especially to make them lighter and thinner with greater flexibility while still providing the same or better performance. Typically, soft penetration-resistant materials comprise of high-strength fabrics such as Kevlar® and ultra-high molecular weight polyethylene (UHMWPE). In order to prevent lethal injuries against different types of threats, several layers of fabric are stacked together which makes the final product relatively heavy and stiff. Various commercial products are available for puncture/stab protection, such as Kevlar Correctional™ from Dupont, which is made of high thread count Kevlar® fabric. However, this product is relatively expensive to manufacture and is not capable of providing sufficient ballistic protection. Coated fabrics, such as Twaron© Stab Resistant Material (SRM) made of Twaron© fabric coated with a silicon carbide polymer matrix composite provides a better stab resistance compared to untreated fabric. For instance, stab penetration work of a 12-layer stack of Twaron© fabric spray-coated with WC Co 83/17 cermet and Al₂O₃/AlSi 12 is about 1 J compared to 0.2 J for untreated Twaron© fabric, albeit with a significant weight increase. Another example is two-layer nylon coated UHMWPE fabric target with 80% higher puncture resistance than three-layer neat fabric target of equivalent areal density. Nylon coated UHMWPE fiber also shows 14-37% and 17-36% higher creep resistance and breaking force (respectively) compared with those of neat fiber at various temperatures. In another approach, flexible fabric with printed arrays of hard platelets of ceramic-polymer composite onto its surface has been used to fabricate a material called SuperFabric® in order to resist needle stick penetration. Here, the platelets that were bonded resisted puncture and cut threats. Nevertheless, the spaces between the plates were a weak point and multi-layer construction is needed to provide effective resistance.

Alternatively, non-Newtonian shear thickening fluids have also been used to fabricate flexible “Fluid Armour” that provides improved stab resistance. In one example, the fluid armour comprising a shear thickening fluid (STF) was impregnated into a high-performance fabric (e.g., Kevlar®, UHMWPE, or nylon) and was shown to provide about 40-100% higher energy absorption against puncture and stab threats compared to textile-only samples of comparable areal densities. In this example, it was shown that the penetration resistance of four-layer STF impregnated Kevlar® fabric is improved about 60 and 260% against 12- and 22-gauge hypodermic needles (respectively) compared to four-layer neat Kevlar®, albeit with a 15% increase in areal density and about 20% increase in thickness. Despite the high penetration resistance provided by the STF, STFs have a number of limitations. These include propensity to leak due to their liquid state, their hygroscopic nature which absorbs ambient moisture and degradation due to exposure to moisture.

One common method to make STFs for the manufacture of liquid body armour is to centrifuge colloidal silica (CS) with a liquid polymer, such as polyethylene glycol (PEG) or ethylene glycol (EG). As a result, water could be replaced with the liquid polymer and the remaining mixture consists of only silica particles and the polymeric liquid medium. The ballistic performance of one-, two-, and four-layer Twaron® fabric systems against high speed spherical projectiles was improved when the targets were still wet after impregnating in silica colloidal water suspension (SWS) up to 40 wt. % loading of particles. Beyond this particle concentration, the ballistic performance of the treated fabric system diminished below that of neat fabric and the effectiveness of such a treatment was found to be less significant on a 6-ply configuration of the same fabric. CS is also used as an effective reinforcing filler in polydimethylsiloxane (PDMS) and has been shown to have better wettability and easier processing than fumed silica. In one study, the difficulty of mixing high loading of monodispersed silica powder in PDMS was reported because of the high viscosity of this elastomer. On the contrary, an STF mixture of silica particles in EG medium with higher loading concentration provided better ballistic response because of higher inter-particle contacts. CS functionalized in isopropanol (IPA), methylethylketone (MEK), or methyltrimethoxysilane coupling agent could be dispersed better in PDMS which resulted in higher mechanical properties of the bulk PDMS composite because of increased filler-polymer and filler-filler interactions.

### SUMMARY

In one aspect, a penetration-resistant composite is described herein. The penetration-resistant composite includes a woven or non-woven substrate and an elastomeric binder covering at least a portion of the substrate. The elastomeric binder includes a polymeric base and particles dispersed within the polymeric base. The particles include one or more of amorphous silica particles, fumed silica particles, boron nitride particles, calcium chloride particles, aluminum oxide particles, calcium carbonate particles, graphite particles, metallic glass particles and silicon carbide particles. The particles have a concentration in a range of about 0 wt. % to about 80 wt. % of the elastomeric binder. The particles have a size in a range of about 1 nanometers to 100 micrometers.

In some embodiments, the particles have a concentration in a range of about 50 wt. % to about 80 wt. % of the elastomeric binder.

In some embodiments, the particle concentration is higher than a critical limit to cause jamming of the particles within the elastomeric binder when the composite is compressed.

In some embodiments, the polymeric base is selected from a class of chemicals including silicones, thermoplastic elastomers, natural or synthetic rubbers, fluoro or perfluoro elastomers and elastoolefins.

In some embodiments, the polymeric base comprises one or more of polydimethylsiloxane (PDMS), thermoplastic polyurethane (TPU), styrenic block copolymers (TPS), poly isoprene, butyl rubber, nitrile rubber and fluorosilicone rubber.

In some embodiments, the particles include one or more of silica (SiO2) and/or silicon carbide (SiC) particles.

In some embodiments, the particles are spherical, oval, elongated or sheet like.

In some embodiments, the substrate and the elastomeric binder form one layer of a plurality of layers of the composite.

In some embodiments, the substrate is woven, non-woven, or 0°/90° cross-plied of continuous fibres of aramid, nylon polypropylene, polyethylene, S-Glass, or polybenzobisoxazole (PBO), polyester, or cotton fibers.

In another aspect, a method of forming a penetration-resistant composite is described herein. The method includes mixing particles with a pre-polymer of an elastomeric binder to form a pre-polymer mixture, the particles including one or more of amorphous silica particles, fumed silica particles, boron nitride particles, calcium chloride particles, aluminum oxide particles, calcium carbonate particles, graphite particles, metallic glass particles and silicon carbide particles, each of the particles having a having a diameter in a range of about 10 nanometers to 50 micrometers. The method also includes infusing the prepolymer mixture into a substrate and curing the infused substrate using heat, air-drying or optical means to form the penetration-resistant composite.

In some embodiments, mixing the particles into the pre-polymer of the elastomeric binder includes mixing a colloidal silica with the particles and the elastomeric binder.

In some embodiments, the elastomeric binder includes PDMS and the particles have a concentration in a range of about 0 to about 80 wt. % of the elastomeric binder.

In some embodiments, mixing the particles with the pre-polymer of the elastomeric binder includes mixing an alcohol solvent with the pre-polymer mixture.

In some embodiments, the solvent is selected from a group of lower alkanols including methanol, ethanol, propanol, butanol and cyclohexanol.

In some embodiments, prior to mixing the particles with the elastomeric binder, the particles are mixed with a colloidal silica and treated with an alcohol solvent to form a particle mixture, and the particle mixture is mixed with the pre-polymer of the elastomeric binder.

In some embodiments, the method further includes, prior to infusing the prepolymer mixture in the substrate, performing a plasma treatment to the substrate.

In some embodiments, infusing the prepolymer mixture into the substrate includes soaking the substrate in the prepolymer mixture for about one minute.

In some embodiments, infusing the prepolymer mixture into the substrate further includes, after soaking the substrate in the prepolymer mixture, passing the substrate through a manual cold laminator to remove excess prepolymer mixture from the substrate.

In another aspects, articles including a penetration-resistant composite described herein are described herein.

In some embodiments, the article is a security vest, body armor, or blast proof shields or the like.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

The drawings included herewith are for illustrating various examples of articles, methods, and apparatuses of the present specification. In the drawings:

FIGS. 1A and 1B show an exemplary needle-stick penetration test setup and a close view of 21 G 1-½″ hypodermic needle according to one embodiment, respectively;

FIG. 2 shows a schematic diagram of the test setup used to measure the bending angle;

FIG. 3 shows images of a fabric target undergoing penetration test (A) before contact, (B) initial fabric puncture, and (C) end of needle penetration, where the top row shows the aforementioned images on a neat fabric and the bottom row shows images on a coated fabric, each under the maximum pre-set load of 10 N;

FIG. 4A shows a top view SEM image of a neat HDPE fabric sample before a needle puncture test (the scale bar is 200 μm);

FIG. 4B shows a top view SEM image of a neat HDPE fabric sample after a needle puncture test (the scale bar is 500 μm);

FIG. 5 shows force versus displacement graphs from penetration test results with a 21 G 1-½″ hypodermic needle on: ●, neat fabric; ▪, coated with PDMS; ▾, coated with 47 wt. % silica (25 nm) in PDMS mixture; ▴, coated with 80 wt. % silica (25 nm) in PDMS mixture; ♦, coated with 80 wt. % particles (1:2 weight ratio of 25 nm silica and 400 nm silica) in PDMS mixture; ★, coated with 80 wt. % particles (1:2 weight ratio of 25 nm silica and 0.5 μm SiC) in PDMS mixture;

FIG. 6 shows a plot of measured peak load and bending angles as well as calculated average energy dissipation of various one-layer target samples undergoing penetration tests;

FIG. 7 shows a plot of normalized peak load and normalized average energy dissipation of various one-layer target samples;

FIG. 8A shows a top view SEM image of a coated HDPE fabric sample before a needle puncture test, the coated fabric sample being 20 wt. % silica (25 nm) in PDMS mixture (the scale bar is 200 μm);

FIG. 8B shows a top view SEM image of a coated HDPE fabric sample before a needle puncture test, the coated fabric sample being 47 wt. % silica (25 nm) in PDMS mixture (the scale bar is 200 μm);

FIG. 8C shows a top view SEM image of a coated HDPE fabric sample before a needle puncture test, the coated fabric sample being 65 wt. % silica (25 nm) in PDMS mixture (the scale bar is 200 μm);

FIG. 8D shows a top view SEM image of a coated HDPE fabric sample before a needle puncture test, the coated fabric sample being 80 wt. % silica (25 nm) in PDMS mixture (the scale bar is 200 μm);

FIG. 8E shows a top view SEM image of a coated HDPE fabric sample before a needle puncture test, the coated fabric sample being 80 wt. % particles (1:2 weight ratio of 25 nm silica and 400 nm silica) in PDMS mixture (the scale bar is 200 μm);

FIG. 8F shows a top view SEM image of a coated HDPE fabric sample before a needle puncture test; the coated fabric sample being 80 wt. % particles (1:2 weight ratio of 25 nm silica and 0.5 μm SiC) in PDMS mixture (the scale bar is 200 μm);

FIG. 9A shows a top view SEM image of a coated HDPE fabric sample after a needle puncture test, the coated fabric sample being 20 wt. % silica (25 nm) in PDMS mixture (the scale bar is 500 μm);

FIG. 9B shows a top view SEM image of a coated HDPE fabric sample after a needle puncture test, the coated fabric sample being 47 wt. % silica (25 nm) in PDMS mixture (the scale bar is 500 μm);

FIG. 9C shows a top view SEM image of a coated HDPE fabric sample after a needle puncture test, the coated fabric sample being 65 wt. % silica (25 nm) in PDMS mixture (the scale bar is 500 μm);

FIG. 9D shows a top view SEM image of a coated HDPE fabric sample after a needle puncture test, the coated fabric sample being 80 wt. % silica (25 nm) in PDMS mixture (the scale bar is 500 μm);

FIG. 9E shows a top view SEM image of a coated HDPE fabric sample after a needle puncture test, the coated fabric sample being 80 wt. % particles (1:2 weight ratio of 25 nm silica and 400 nm silica) in PDMS mixture (the scale bar is 500 μm);

FIG. 9F shows a top view SEM image of a coated HDPE fabric sample after a needle puncture test; the coated fabric sample being 80 wt. % particles (1:2 weight ratio of 25 nm silica and 0.5 μm SiC) in PDMS mixture (the scale bar is 500 μm);

FIG. 10 shows force versus displacement graphs from penetration test results with a 21 G 1-½″ hypodermic needle on: ●, five-layer neat fabric; ▴, two-layer coated with 80 wt. % silica (25 nm) in PDMS mixture; ♦, two-layer coated with 80 wt. % particles (1:2 weight ratio of 25 nm silica and 400 nm silica) in PDMS mixture; ★, two-layer coated with 80 wt. % particles (1:2 weight ratio of 25 nm silica and 0.5 μm SiC) in PDMS mixture;

FIG. 11 shows histograms of peak load, average energy dissipation, and flexibility of various target samples of multiple stacked layers;

FIG. 12 shows a plot of normalized peak load and normalized average energy dissipation of various target samples of multiple stacked layers;

FIG. 13A shows a schematic diagram of a penetration test setup, according to one embodiment;

FIG. 13B shows a stylus-like spike according to EN 388:2015 standard (millimeter-scale);

FIG. 14A shows images of the fabric samples undergoing a spike penetration test under a maximum pre-set load of 100 N at the start of penetration, the top row is a 3-layer stack of neat fabric and the bottom row is 2-layer stack of coated fabric with 50 wt. % SiC in PU (millimeter-scale);

FIG. 14B shows images of the fabric samples undergoing a spike penetration test under a maximum pre-set load of 100 N at the end of penetration, the top row is a 3-layer stack of neat fabric and the bottom row is 2-layer stack of coated fabric with 50 wt. % SiC in PU (millimeter-scale);

FIG. 14C shows images of the fabric samples undergoing a spike penetration test under a maximum pre-set load of 100 N showing a top close-view of the impact area, the top row is a 3-layer stack of neat fabric and the bottom row is 2-layer stack of coated fabric with 50 wt. % SiC in PU, where the arrow shows the point of contact on the coated sample (millimeter-scale);

FIGS. 15A-F show top view before-puncture-test SEM images of plasma-treated/not-treated UHMWPE fabric coated with different mixtures of SiC in PU (the scale bar is 500 μm);

FIG. 16 shows a top view of plasma-treated/not-treated UHMWPE fibers: (a) the scale bar is 20 μm, (b) the scale bar is 10 μm;

FIG. 17 shows a plot of force versus displacement graphs from the spike penetration test on single-layer plasma-treated UHMWPE fabric samples: —, neat; —, coated with PU; •••, coated with 30 wt. % SiC in PU; - - -, coated with 50 wt. % SiC in PU;

FIGS. 18A-F show top/rear view after-puncture-test images of plasma-treated/not-treated UHMWPE fabric coated with different mixtures of SiC in PU (millimeter-scale);

FIGS. 19A-F show top view after-puncture-test SEM images of plasma-treated/not-treated UHMWPE fabric coated with different mixtures of SiC in PU (the scale bar is 500 μm);

FIG. 20 shows a plot of force-displacement curves from spike penetration tests of neat and coated UHMWPE fabric samples without prior oxygen-plasma treatment;

FIG. 21 shows a plot of measured maximum resistance force, bending angle, and areal density of plasma-treated neat and coated UHMWPE fabric of various layers undergoing spike-penetration tests;

FIG. 22 shows a plot of force versus displacement graphs from the 25 G needlestick penetration test on single-layer UHMWPE fabric samples: —, neat; —, plasma-treated and coated with PU; •••, plasma-treated and coated with 30 wt. % SiC in PU; - - -, plasma-treated and coated with 50 wt. % SiC in PU; and

FIG. 23 shows a plot of measured peak resistance force, bending angle, and areal density of plasma-treated neat and coated UHMWPE fabric of various layers undergoing 25 G needlestick penetration tests.

### DETAILED DESCRIPTION

Various apparatuses or processes will be described below to provide an example of each claimed embodiment. No embodiment described below limits any claimed embodiment and any claimed embodiment may cover processes or materials that differ from those described below. The claimed embodiments are not limited to materials or processes having all of the features of any one material or process described below or to features common to multiple or all of the materials described below. It is possible that a material or process described below is not covered by any of the claimed embodiments. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As one of ordinary skill would appreciate, different persons may refer to the same feature or component by different names. This document does not intend to distinguish between components or features that differ in name only. In the following description and in the claims, the terms “including” and “comprising” are used in an open-ended fashion, and thus, should be interpreted to mean “including, but not limited to.”

The articles “the,” “a” and “an” are not necessarily limited to mean only one, but rather are inclusive and open ended to include, optionally, multiple such elements.

As used herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure.

The term “particles” used herein refers to micro- or nanoscale particles that vary in type from the elastomeric matrix with which they are mixed. For instance, as described below, the particles generally have a size (e.g. diameter) in a range of about 1 nanometer to about 100 micrometers. The particles may be spherical, oval, elongated or sheet-like.

One object of the present disclosure is to provide a penetration-resistant composite material. The composite is generally flexible and includes a substrate and an elastomer configured to coat and/or impregnate at least a portion of the substrate. The elastomer includes micro- and/or nano-sized particles.

Generally, the substrate is flexible. For example, the substrate may be a flexible textile consisting of a network of natural or artificial woven or non-woven fibers. In some embodiments, the substrate may be but is not limited to high-density polyethylene (HDPE) woven fabrics. In other examples, the substrate may include but is not limited to an ultra-high molecular weight polyethylene fiber, an ultra-high molecular weight polypropylene fiber, an aramid fiber, an ultra-high molecular weight polyvinyl alcohol fiber or mixtures thereof. In other embodiments, typical textile-based resistant materials may comprise of high-strength fibers (HSFs) such as aramid, S-glass, ultra-high molecular weight polyethylene (UHMWPE), polypyridobisimidazole (PIPD), and polyphenylene benzobisoxazole (PBO).

The substrates described herein are generally coated and/or impregnated with one or more polymeric and non-polymeric materials. For instance, the substrates may be coated with a low modulus, elastomeric material (i.e. an elastomeric binder).

Generally, elastomeric materials and/or elastomeric formulations are also described for coating the substrate. In some embodiments, the elastomeric materials are selected from a class of materials including but not limited to silicones, thermoplastic elastomers, natural or synthetic rubbers, fluoro or perfluoro elastomers and elastoolefins. The elastomeric materials and/or elastomeric formulations have a polymeric base, such as but not limited to a polydimethylsiloxane base or a polyurethane base.

Generally, the elastomers include one or more micro- and/or nano-sized particles such as but not limited to one or more of amorphous silica particles, fumed silica particles, boron nitride particles, calcium chloride particles, aluminum oxide particles, calcium carbonate particles, graphite particles, metallic glass particles, silicon carbide particles or the like. The micro- and/or nano-sized particles generally have a size (e.g. diameter) in a range of about 1 nanometers to about 100 micrometers, or a range of about 10 nanometers to 50 micrometers.

In some embodiments, the particles include silica (SiO₂) and/or silicon carbide (SiC) particles.

In some embodiments, the particles may have a concentration in a range of about 0 wt % to about 80 wt % when mixed with the elastomeric material, or in a range of about 10 wt % to about 80 wt % when mixed with the elastomeric material, or in a range of about 30 wt % to about 80 wt % when mixed with the elastomeric material, or in a range of about 50 wt % to about 80 wt % when mixed with the elastomeric material. In some embodiments, the elastomeric materials may include high concentrations of particles mixed therein. For instance, the particles may have a concentration of about or more than 50 wt % when mixed with the elastomeric material, a concentration of about or more than 60 wt % when mixed with the elastomeric material, a concentration of about or more than 70 wt % when mixed with the elastomeric material, or a concentration of about 80 wt % when mixed with the elastomeric material.

Another object of the present disclosure is to provide a method of forming a penetration-resistant composite material.

In some embodiments, the methods of forming the composite include coating and/or impregnating and/or infusing a substrate (e.g. HDPE woven fabrics) with a mixture comprising an elastomer and particles. For instance, the mixture of the elastomer and the particles can be formed using colloidal silica (CS) and PDMS. Herein, colloidal silica generally refers to a suspension of fine amorphous, nonporous, and typically spherical silica particles, or the like, in a liquid phase. The liquid phase may include but is not limited to water.

In some embodiments, mixing particles describe herein with a pre-polymer of an elastomeric binder to form a pre-polymer mixture includes mixing particles including one or more of amorphous silica particles, fumed silica particles, boron nitride particles, calcium chloride particles, aluminum oxide particles, calcium carbonate particles, graphite particles, metallic glass particles or silicon carbide particles. The particles generally have a diameter in a range of about 10 nanometers to 50 micrometers.

After mixing the particles with the elastomeric material, the methods described herein include coating, or impregnating or infusing the prepolymer mixture into a substrate. For instance, impregnating or infusing the prepolymer mixture into a substrate may include soaking the substrate in the prepolymer mixture to provide for the prepolymer mixture to coat at least a portion of the substrate and/or to soak into the woven and/or nonwoven fibres of the substrate.

After coating, or impregnating or infusing the prepolymer mixture into the substrate, the methods described herein include curing the infused substrate. The infused substrate may be cured using heat, air-drying, optical means or any other technique to cure an elastomer described herein.

In some embodiments, the substrates may undergo a treatment process prior to being coated and/or impregnated with the elastomer. For instance, in some embodiments, the substrate may undergo a plasma treatment process prior to being coated and/or impregnated with the elastomer. The plasma treatment process may include exposing the substrate to an oxygen plasma.

In some embodiments, the particles may be mixed with or include a colloidal silica during mixing of the particles with the prepolymer. Mixing or including the particles with or as a colloidal silica may provide for dispersing the particles into the prepolymer of the elastomer and may provide for a higher percentage of particles to disperse within the elastomer when compared to mixing a dry powder of the particles. For instance, mixing particles with a colloidal silica during mixing of the particles with the prepolymer, or mixing particles with a colloidal silica prior to mixing the mixed particles and colloidal silica with the prepolymer, may provide for improved dispersion and/or improved yields of particles in the prepolymer when compared to mixing a dry powder of the particles with the prepolymer.

In some embodiments, mixing the particles with the pre-polymer of the elastomeric binder includes mixing an alcohol solvent with the pre-polymer mixture.

In some embodiments, the solvent is selected from a group of lower alkanols including methanol, ethanol, propanol, butanol and cyclohexanol.

In some embodiments, the solvent is an organic solvent.

In some embodiments, prior to mixing the particles with the elastomeric binder, the particles are mixed with a colloidal silica and treated with an alcohol solvent to form a particle mixture, and the particle mixture is mixed with the pre-polymer of the elastomeric binder.

In some embodiments, prior to infusing the prepolymer mixture in the substrate, performing a plasma treatment to the substrate.

In some embodiments, infusing the prepolymer mixture into the substrate includes soaking the substrate in the prepolymer mixture for about one minute.

In some embodiments, infusing the prepolymer mixture into the substrate further includes, after soaking the substrate in the prepolymer mixture, passing the substrate through a manual cold laminator to remove excess prepolymer mixture from the substrate.

In some embodiments, curing the infused substrate forms a layer of the penetration-resistant composite, and the method further comprises stacking two or more layers of the infused substrate and forming the penetration using a compression mold press.

In some embodiments, the composite may be coated with a nylon coating to form a light-weight flexible protective material.

In some embodiments, the composite may be coated with a shear thickening fluid (STF) material to form a light-weight flexible protective material.

The composites described herein may be included in an article to provide penetration resistance to the article. For instance, the article may include a garment such as but not limited to a security vest, body armor, or blast proof shields, a protective element such as but not limited to gloves, or the like.

In some embodiments, the composites described herein show up to or about a 90% increase in specific penetration resistance force (SPRF) to hypodermic needles compared to the neat fabric. Resistance to penetration is dependent on the concentration of the micro- and/or nanoparticles (e.g. hard silica particles) in the elastomeric matrix. Furthermore, by adding particles such as but not limited to silicon carbide nanoparticles to CS and mixing the CS with an elastomer such as but not limited to PDMS such that the particles have a concentration of about 80 wt. % of the total mixture, the SPRF can be increased to about 110% compared with that of one-layer neat fabric. In some embodiments, when forming the penetration-resistant composite, the particles may have a concentration that is higher than a critical limit, where the critical limit causes the particles to jam against one another. At high particle concentrations, there may be sufficient density of particles within the elastomer to form a of percolation network of particles that form upon impact which could distribute the load over a larger area, offer higher resistance to impact and prevent failure of the material. The PDMS provides a thin elastomeric layer between the particles that is quickly compressed to limit at the initial stages of impact. Further compression leads to the formation of percolation networks that then arrest further deformation and distribute the load. Interestingly, similar formation of percolation networks has been observed in highly particle loaded liquids. Here, instead of compressive forces, shear is used to initiate the formation of percolation networks of particles that could instantaneously “jam” the liquid and create a semi-solid like state in a phenomenon termed “shear jamming”.

In some embodiments, composites described herein can be stacked in layers (e.g. in two or more layers). For instance, in some embodiments a two-layer stack of the same treated fabric can provide a 190% higher SPRF while being 40% less in thickness as compared to a five-layer stack of neat fabric having the same areal density. In some embodiments, the two-layer stack was able to completely prevent the penetration of a 21 G needle at a speed of 50 cm/min (according to ASTM standards) in about one-third of the performed experiments while a five-layer stack of neat fabric, was easily penetrated. These results demonstrate that impregnation of textiles with high concentrations of nano-sized hard particles in an elastomeric matrix can be an attractive method for the manufacture of needle stick penetration-resistant garments.

In some embodiments, composite materials comprising plasma-treated ultra-high molecular weight polyethylene (UHMWPE) fabric that has been dip-coated into a nanoparticle-laden elastomeric mixture are described herein. The elastomeric mixture comprises of SiC nanoparticles of 0.5 μm diameter and a polyurethane (PU)-based polymer. The nanoparticles may be loaded at various weight percentages, such as but not limited to 0, 30, and 50 wt. %.

In some embodiments, the maximum penetration resistance force of a single-layer uncoated UHMWPE fabric may increase up to about 218% due to the loading of nanoparticles.

In some embodiments, two- and five-layer stacks of coated fabric may show up to about 57 and 340% higher spike-puncture and hypodermic-needle resistance, respectively, when compared to a 7-layer stack of neat fabric.

In some embodiments, two- and five-layer stacks of coated fabric may be more flexible and about 21-55% thinner compared to a 7-layer stack of neat fabric (of comparable areal density).

### EXAMPLE 1

In one example, penetration tests and characterization were performed for exemplary composites.

Materials and Methods

In one example, colloidal silica (LUDOX® TM-50) was a 50 wt. % suspension in H₂O, with specific surface area approximately 140 m2/g, 1.4 g/mL at 25° C., and pH=9 was purchased from Sigma-Aldrich, Canada. The amorphous silica powder (SiO2) had diameter of 400 nm, specific surface area of 35 m2/g, true density of 1800-2400 kg/m3, and bulk density smaller than 900 kg/m3 was purchased from US Research Nanomaterials, Inc. Houston, USA, and the silicon carbide (SiC) particles had a diameter of 0.5 μm and specific surface area of 4-8 m2/g was purchased from Panadyne Inc. Montgomeryville, USA. The PDMS polymer was purchased as Sylgard® 184 which is a silicone elastomer kit from Dow Corning Corporation, USA. The kit comprises of Base/Curing Agent to be mixed in a 10 (base):1 (curing agent) ratio by weight. Sylgard® 184 is highly flexible with low water absorption and high thermal stability over a wide temperature range (−45 to 200° C.), which makes it an ideal choice for our application. A high-density polyethylene (HDPE) plain weave fabric with an areal density of 285 g/m2, thickness of 0.5 mm, and thread count of 60×60 was used in this study.

Sample Fabric Preparation

CS was first added gradually to the pre-polymer base part of Sylgard® 184 to make the composite base mixture. Different compositions corresponding to silica particle loadings of 20, 35, and 47 wt. % of the final mixture (i.e. the total weight of particles, pre-polymer, and curing agent) were prepared. The maximum loading of silica that could be completely hand-mixed with the pre-polymer base was limited to about 47 wt. % of the total mixture. The well-stirred dispersion was then mixed with the required amount of cross-linking curing agent (10 pre-polymer base:1 curing agent ratio by weight) and stirred for 15 minutes. The HDPE fabric was cut to 5 cm×10 cm samples and then soaked in the mixture for one minute. A sharp edge scraper was used at the same time to facilitate the coating process by forcing the mixture into the fabric samples. Finally, the fabric was passed through a manual cold laminator with a gap size of 0.7-0.8 mm to remove excess material. The samples were cured in an oven at 80° C. for a period of seven hours. In order to achieve silica particle loadings greater than 47 wt. % of the mixture, a different manufacturing method was developed. Here, the CS was functionalized by gradually mixing isopropanol (IPA) solvent at room temperature so the weight ratio of ISP to water in CS was 0.4. The pre-polymer base part was then dispersed gradually into the solution of CS and IPA and stirred. The uniform mixture was mixed with the cross-linking curing agent and stirred for an additional 15 minutes to produce a final composition of 65 wt. % silica particles—35 wt. % PDMS or 80 wt. % silica particles—20 wt. % PDMS. The fabrics were then coated with the mixture and cured similar to the previous samples. Additionally, an alternate method was developed by adding amorphous silica powder to CS in order to explore the effect of mixing different particles. In this method, amorphous silica powder was added to the CS in order to increase the loading of particles to 75% of the weight of CS (1:2 weight ratio of 25 nm silica and 400 nm silica). IPA was then added gradually as the weight ratio of IPA to water in CS is 0.4. In the second step, the required pre-polymer and cross-linking agent were added to make a uniform mixture of 80 wt. % particles—20 wt. % PDMS. The fabrics were then soaked, coated, rolled, and heated like previous samples. Similar to the synthesis process of the latter sample, instead of using amorphous silica powder, 0.5 μm SiC particles were added to CS in order to make a final sample of 80 wt. % particles—20 wt. % PDMS.

Needle-Stick Penetration Test

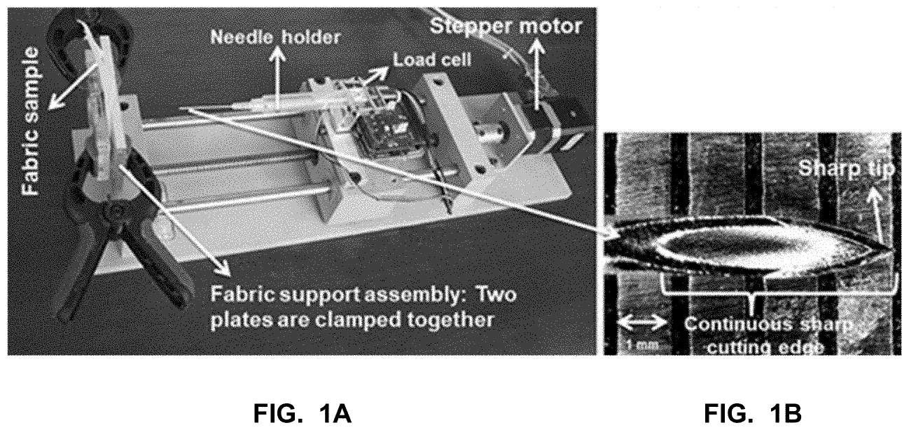

A needle-stick penetration test apparatus was designed and fabricated according to ASTM F2878-10 standard (FIG. 1). A needlestick holder was mounted on a traverse that was driven by a stepper motor which was controlled via a computer. A 5 kg load cell was mounted at the back end to measure the force exerted on the needle and the traverse speed was set to 500 mm/min. A supporting fixture holds the fabric target firmly and the fabric sample was sandwiched between two concentric plates with an open internal diameter of 20 mm by tightening of two bar clamps. A rubber O-ring was also mounted between the opposing surfaces of the two plates of the fixture similar to the ring clamp attachment in accordance with ASTM D4833-00E1 to prevent fabric slippage. The fabric was then exposed to the needle. The accuracy of the testing apparatus was confirmed by testing on the calibration material suggested by the ASTM F2878-10. A fresh 21 G 1-½″ (BD305167) hypodermic needle stick was used for each test and repeated at least fifteen times on three similar samples to ensure reproducibility of the results. The maximum penetration force required to puncture the fabric sample and the force-displacement curves were recorded accordingly. The area under each typical force-displacement curve was calculated up to 10 mm penetration of needle through the fabric in order to estimate the total energy dissipation (i.e., work done) during penetration. Multiple-layer stack of fabric samples were tested against needle penetration in a similar manner. A Specific Penetration Resistance Force (SPRF) and Specific Energy Absorbed (SEA) were defined as the maximum penetration resistance force or average energy dissipation divided by the areal density of the fabric sample. These parameters are used to compare the target samples based on their mass efficiency.

Flexibility Test

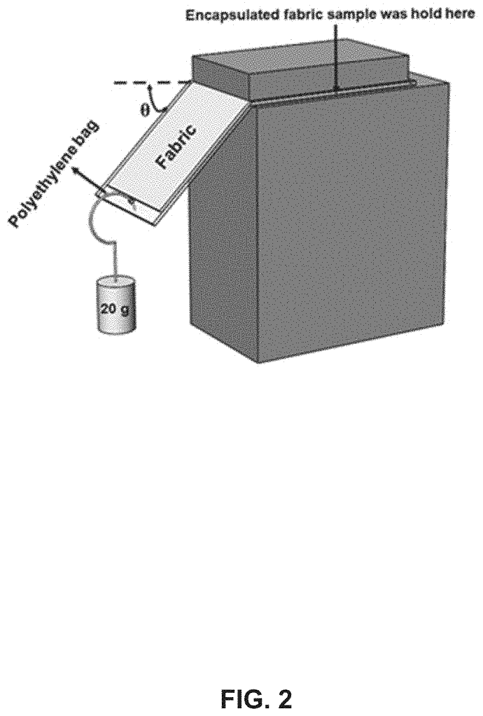

The flexibility of the fabric was characterized on 5 cm×10 cm sample pieces (FIG. 2). Each sample was sealed in a soft polyethylene bag and held firmly at the edge of a table with an overhang of 3.8 cm of the length of the sample. A 20 g weight was attached to the middle end of the encapsulated sample and its bending angle (BA) was measured from a captured image. The bending angle is a measure of the flexibility of the fabric and these flexibility tests are in accordance with previous research studies similar to ASTM D1388.

Image Analysis

Scanning electron microscopy (SEM) analysis was carried out using a VEGA-LSU TESCAN VP to study the damage mechanism of the fabrics. The samples were coated with a gold material to prevent charge build-up. The diameter of the monodispersed spherical silica particles in CS was measured to be 25±5 nm from images taken by JEOL 1200EX TEMSCAN Transmission Election Microscope (TEM).

Results

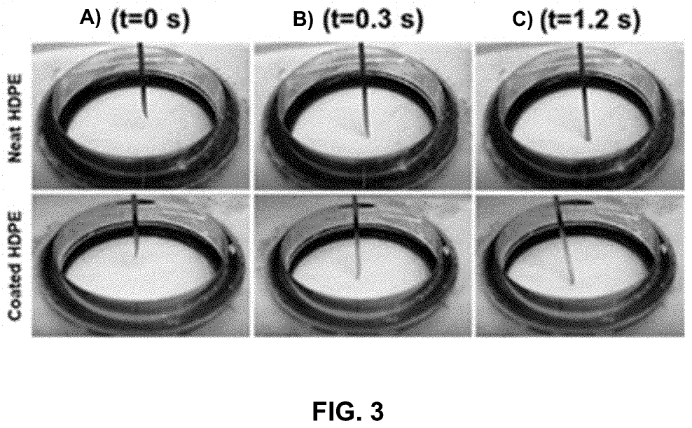

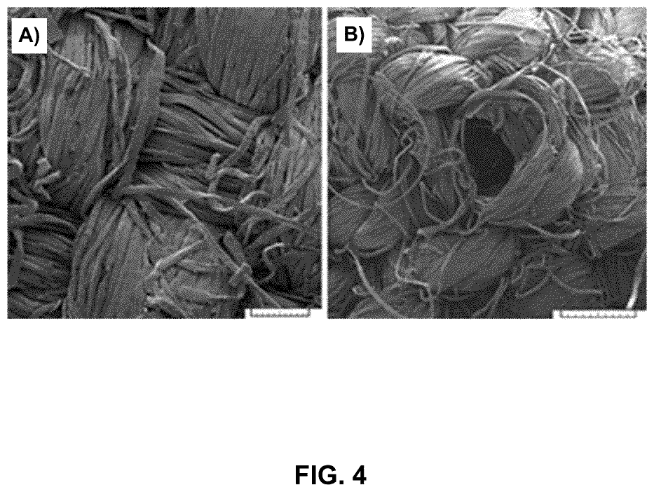

An initial needle penetration test was conducted in order to demonstrate the effectiveness of the nanoparticle-elastomer composite. The images in FIG. 3 show the point of contact of the needle with two different target samples under the maximum pre-set load of 10 N. The top row shows the penetration of a five-layer stack of neat HDPE fabric while the bottom row shows the same experiment performed on a two-layer stack of coated HDPE fabric (coated with 80 wt. % silica particles in PDMS mixture) of similar areal density. It can be seen that the pre-set 10 N load was able to easily penetrate the five-layer stack of neat HDPE fabric. A microscopic analysis of the penetration was conducted by imaging the neat fabric before and after penetration as shown in FIG. 4. The loosely weaved fibers on the neat fabric (FIG. 4(a)) are noticeably pushed aside and separated (FIG. 4(b)) during to the penetration of the needle. This is typical of textile-only structures as the dominant failure mechanism is the “windowing effect” where the fibers are spread-apart and pushed away creating an open area for a penetrator to pierce through the fabric.

In comparison, the needle with a 10 N pre-load was not able to pierce through the two-layer stack of the coated fabric and instead was bent slightly. This dramatic difference in performance occurs despite the coated fabric stack having 40% lower thickness and the same flexibility as the five-layer neat fabric stack and warranted further investigation to characterize this phenomenon.

Effect Particle Concentration on Penetration Force, Flexibility, and Areal Density

Various single-layer samples of different particle loading were tested and compared to study the effect of particle concentration (from 0% to 80%) on the penetration resistance, flexibility, and areal density of the fabric. The effect of mixing two different types of particles (silica and SiC) in the PDMS mixture was also studied. Additionally, SEM image analysis was performed to infer the failure mechanism. The average thickness of the fabric samples was found to increase by 20-80% due to the coating, while the average increase in areal density was approximately 120-180%. Two exceptions were the coated samples with 35 and 47 wt. % silica particles in PDMS mixture which showed about 220-270% increase in areal density compared with the neat fabric.

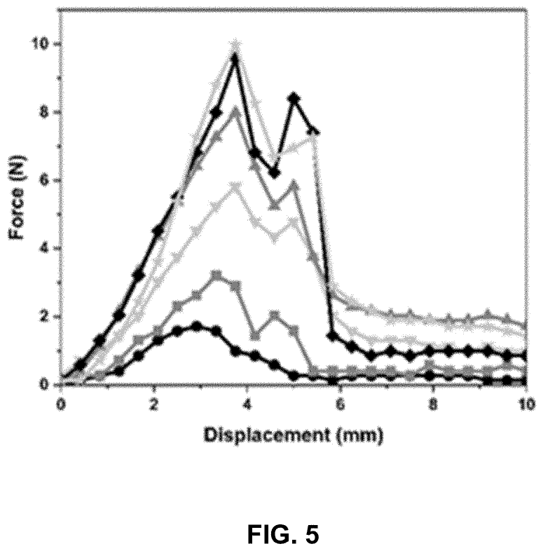

The results of penetration tests performed on one-layer neat and treated fabric samples are shown in FIG. 5. The penetration force as measured by the load cell mounted on the needle increases as the needle comes in contact with the fabric and begins penetration. The maximum penetration resistance force was seen to occur at about 3 to 4 mm after the tip of the needle pierces through the fabric for all cases which matches the total length of the continuous sharp cutting edge of the needle (4 mm) presented in FIG. 1. Such a maximum force is typical of needle penetration in textiles and represents the windowing effect and cutting mechanism. After reaching the maximum, the penetration force drops as the tip of the needle moves through the fabric. A second local peak occurs when the fabric is cut and windowed to the maximum extent and damage-zone size. For the neat fabric, only one force peak was detected unlike the two local maxima for the coated samples. This is likely due to the domination of the “windowing effect” in neat fabrics and very little cutting of the fibers as the needle penetrates through the fabric.

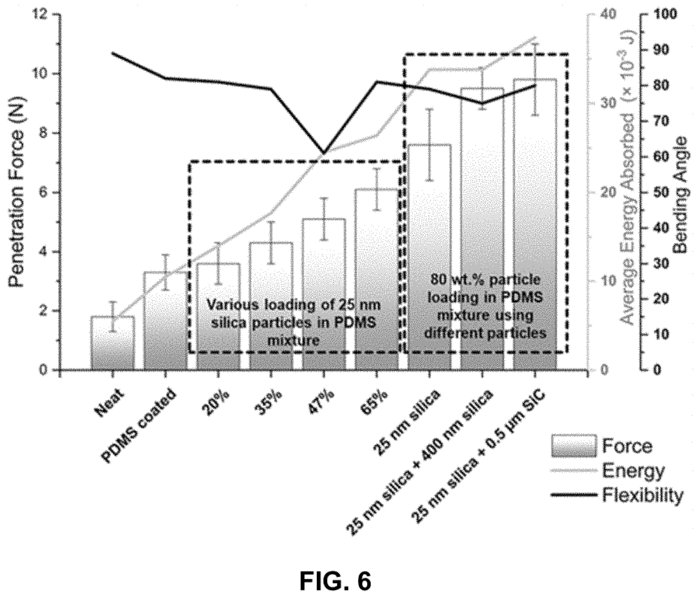

Maximum penetration force, average energy dissipation, and bending-angle histogram plots of one-layer neat and coated samples are presented in FIG. 6. From the flexibility test results, the flexibility of the neat fabric reduced by 8% when coated with only PDMS. The coating with 20, 35, 47 wt. % silica particles to PDMS coating further reduced the flexibility by 9, 11, and 31%, respectively. Surprisingly, the flexibility of the coated samples with 65 wt. % silica particles in PDMS mixture was only 9% lower compared to the flexibility of neat fabric, respectively. Also, the three coated samples with 80 wt. % particle loading in PDMS mixture showed 10-15% reduction flexibility as compared to the neat fabric. Upon further analysis it was noted that, the coated fabric with 47 wt. % of silica in PDMS mixture has the highest areal density and thickness among all samples which resulted in a significant reduction in flexibility. On the contrary, the coated samples with 65 and 80 wt. % of particles in PDMS mixture were thinner and lighter in spite of their higher concentration of particles while using the same coating process. This result indicates a transition in the flow of the particle laden mixture that when loaded higher than a critical particle concentration leads to a shear thinning type behaviour that could promote better filling and packing leading to a thinner coating.

It can be seen from the results that one-layer neat fabric provides a maximum force of 1.8±0.5 N against needle-stick penetration. The peak resistance force increased to 3.3±0.6 N after coating the fabric with PDMS only. The penetration resistance force gradually increased to 3.6±0.7 N for 20 wt. % silica loaded PDMS coating to 5.1±0.6 N for a 47 wt. % silica loaded PDMS coating. However, this increase, especially in the case of 20, 35 wt. %, was not significantly different from the PDMS only coating. Interestingly, the fabrics coated with 65 and 80 wt. % silica loaded PDMS coating showed significantly higher increase in penetration force of 6.1±0.7, and 7.6±1.2 N respectively as compared with the PDMS coated fabric indicating that the particle loading plays a major role in increasing the penetration resistance at higher loading levels.

The work done by the needle penetrator was calculated from the area under the force-displacement curve up to a penetration of 10 mm through the target sample. The energy dissipation was increased over the neat fabric by 91, 155, 222, 345, 380, and 514% by treating one-layer fabric with PDMS and 20, 35, 47, 65, and 80 wt. % silica loading mixtures, respectively. The maximum penetration force increases to 9.4±1.9 N by incorporating amorphous silica powder (400 nm diameter) along with CS (25 nm) to make a uniform mixture of 80 wt. % particles—20 wt. % PDMS. As a result, the penetration resistance force and average energy dissipation during penetration of this sample increased by about 420 and 180% respectively, compared with one-layer neat fabric. Replacing 400 nm silica powder in the latter sample with 0.5 μm diameter SiC powder to the same particle concentration resulted in the highest penetration resistance force (9.8±1.4 N) among all one-layer target samples. The performance of this sample shows 440 and 180% improvement in the penetration resistance force and average energy dissipation, respectively, compared with one-layer neat fabric. Overall, the penetration resistance force and average energy absorbed of the neat fabric improved by increasing the particle concentration from 20 to 80 wt. % in the coating mixture.

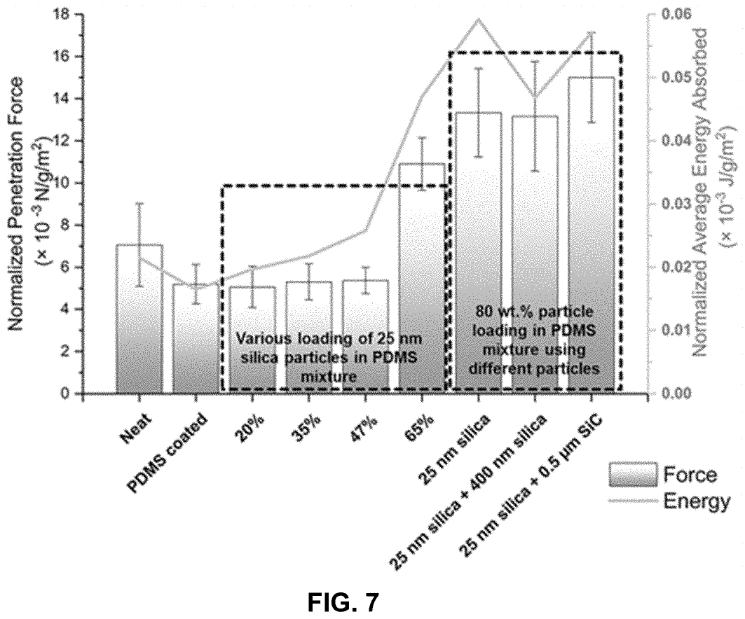

The effect of particle addition is even clearer when force and the energy absorbed are normalized to the areal density. The specific penetration resistance force (SPRF) and Specific Energy Absorbed (SEA) which are normalized by the areal density of the corresponding one-layer samples are plotted as shown in FIG. 7. It can be seen that the SPRF of treated samples reduced and SEA of the coated fabrics are not significantly different from the neat fabric up to a critical concentration of ˜47 wt. % of particles any observed increase in magnitude of the penetration resistance force can be attributed to the increase in the mass loading or areal density. Interestingly, beyond this critical loading, the SPRF and SEA rapidly increases indicating a different phenomenon other than simple mass loading, as a dominant factor in performance.

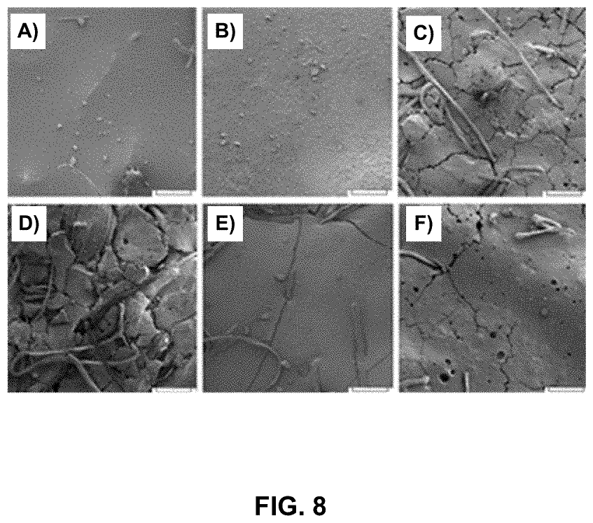

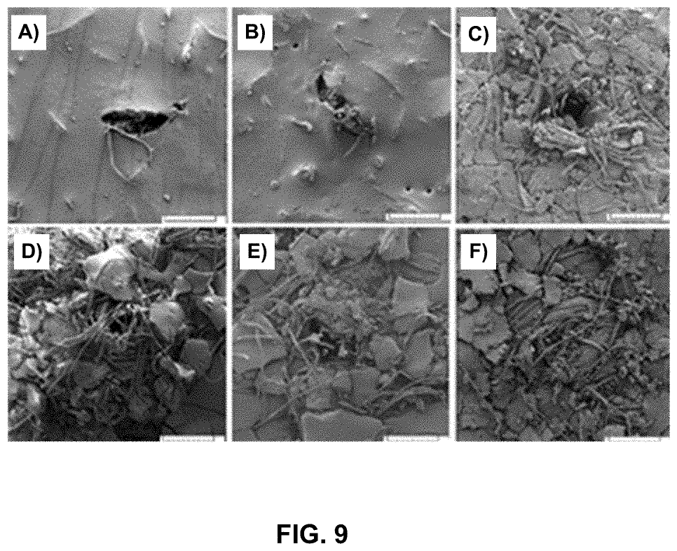

In order to understand the phenomena further, SEM images of the coated samples were taken before and after puncture and shown in FIG. 8 and FIG. 9. It can be seen that the 20 wt. % silica coating resulted in a uniform and smooth surface with no loose fibers (FIG. 8(a)), which indicates good wetting of the fabric by the PDMS. The surface became more granular (FIG. 8(b)) as the loading of silica increased from 20 to 47 wt. %. As the concentration of silica particles is further increased to higher loadings of 65 and 80 wt. % (FIGS. 8(c) and 8(d)), the coating appeared like an assembly of plate-like structures formed due to the limited amount of elastomer present. The PDMS due to its low surface energy is capable of spreading thinly between the particles and holding them in place. These structures are indicative of a coating that is particle dense. Interestingly, when the particle mixture was changed to a mixture of small and large particles (FIG. 8(d) to 8(f)) while still maintaining the same particle loading of 80 wt. %, the surface appears crack free. This could be attributed to the higher packing factor that is possible when smaller particles could be accommodated into the interstitial space between the larger particles which could enable more of the elastomer to be present on the surface.

The after-puncture images of the coated samples (FIG. 9) clearly showed the fibers were not loose and separated at the damage zone as it would be in the case of neat fabric. It indicates that the addition of the PDMS elastomer and the particles allowed the individual fibers to be held closely and reduced the “windowing effect” significantly. It was also observed that the coating material was substantially fractured at the vicinity of the impact area and that the impact damage was lesser as the particle loading was increased, especially beyond 47 wt. %, correlating with the higher penetration resistance of the coated fabrics as more of the impact energy was dissipated.

Reduction in yarn mobility within the fabric has been attributed in the past to the superior penetration resistance of some STF-textile structures. It was also reported that yarn pull-out force increases, and breakage of fibers became more significant compared to fiber slippage and “windowing effect”. A similar effect could contribute to the improved penetration resistance of the current coated samples as a higher loading of hard silica particles is likely to provide more effective coupling mechanism that would increase fiber-fiber and fiber-particle load transferring and suppresses yarn mobility. One explanation for the increase in penetration resistance especially at high particle loading would be due to “elastic jamming” of particle fillers in PDMS. At high particle loading, there is sufficient density of particles that could allow formation of percolation network of particles that form upon impact which could distribute the load over a larger area, offer higher resistance to impact and prevent failure of the material. The PDMS provides a thin elastomeric layer between the particles which is quickly compressed to limit at the initial stages of impact. Further compression leads to the formation of percolation networks that then arrest further deformation and distribute the load. Interestingly, similar formation of percolation networks has been observed in highly particle loaded liquids. Here, instead of compressive forces, shear is used to initiate the formation of percolation networks of particles that could instantaneously “jam” the liquid and create a semi-solid like state in a phenomenon termed “shear jamming”.

Effect of Multiple Layers of Stacked Fabrics on Penetration Resistance

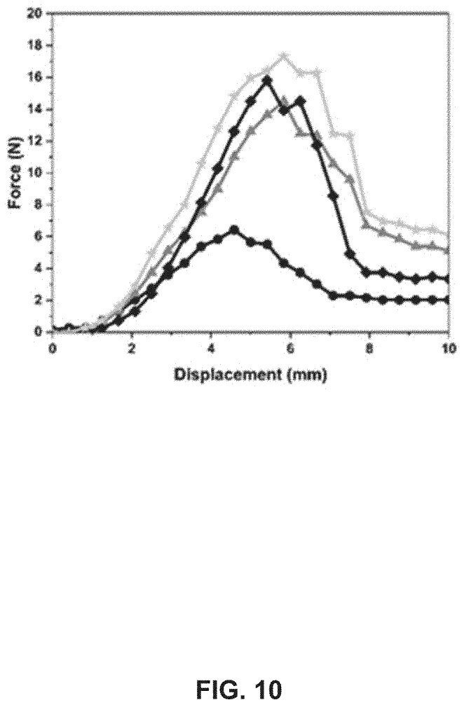

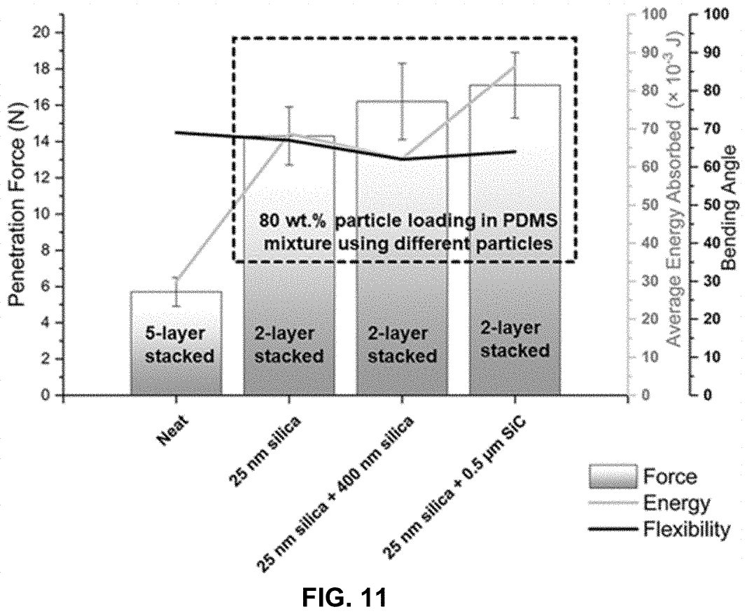

As it may be required to use multiple layers of treated or neat fabric layers in an end-product, it is important to examine the penetration resistance of a stack of fabric layers against hypodermic needles. Therefore, a two-layer stack of treated fabric and a five-layer stack of neat fabric layers of matched areal density were tested and compared. For this comparison, the coated samples with 80 wt. % particle loading which have the highest penetration resistances were chosen. The corresponding penetration force-displacement graphs are presented in FIG. 10. Similar to the plots of coated samples presented in FIG. 5, a second local peak force was present in all four samples including the five-layer stack of neat fabric and can be attributed to the maximum extent of cutting and windowing mechanisms. Additionally, the two-layer stack of treated samples with the mixture of silica and silicon carbide to 80 wt. % of the final mixture resulted in bent needles in about one-third of the penetration tests. The maximum penetration force, average energy dissipation, and bending angles from the flexibility tests are presented in FIG. 11. The change in areal density, thickness, and flexibility after each coating treatment are provided in Table 1. The maximum penetration resistance force of the two-layer coated samples with 80 wt. % loading of “25 nm silica”, “25 nm silica and 400 nm silica”, and “25 nm silica and 0.5 μm SiC” improved by 150, 185, and 200% (respectively) compared to the five-layer stack of neat fabric. The flexibility of the two-layer coated fabric with 80 wt. % particles in PDMS mixture is almost equal to that of the five-layer neat fabric sample with an equivalent areal density. Besides, the thickness of a five-layer stack of neat fabric is considerably larger (approximately 40 percent) than the thickness of the coated samples even though they have a comparable areal density.

TABLE 1
Areal density, thickness and bending
angle of various target samples.

| No. of | | | Approximate | | |
|---|---|---|---|---|---|
| stacked | | | Areal | | |
| fabric | Particle loading | | Density | Thickness | BA |
| layers | in PDMS mixture | | (g/m²) | (mm) | (θ ± 2°) |
| 1 | Neat | | 255 | 0.5 | 89 |
| | PDMS coated | | 635 | 0.60-0.65 | 82 |
| | 20 wt. % | SiO₂ (25 nm) | 711 | 0.70-0.75 | 81 |
| | 35 wt. % | | 810 | 0.70-0.80 | 79 |
| | 47 wt. % | | 950 | 0.85-0.90 | 61 |
| | 65 wt. % | | 560 | 0.60-0.65 | 81 |
| | 80 wt. % | | 670 | 0.70-0.75 | 79 |
| | 80 wt. % | 1:2 weight | 722 | 0.75-0.80 | 75 |
| | | ratio of 25 nm | | | |
| | | silica and 400 | | | |
| | | nm silica | | | |
| | | 1:2 weight | 655 | 0.80-0.85 | 80 |
| | | ratio of 25 nm | | | |
| | | silica and 0.5 | | | |
| | | μm SiC | | | |
| 5 | Neat | | 1275 | ~2.5 | 69 |
| 2 | 80 wt. % | SiO₂ (25 nm) | 1140 | ~1.4 | 67 |
| | | 1:2 weight | 1444 | ~1.6 | 62 |
| | | ratio of 25 nm | | | |
| | | silica and 400 | | | |
| | | nm silica | | | |
| | | 1:2 weight | 1310 | ~1.5 | 64 |
| | | ratio of 25 nm | | | |
| | | silica and 0.5 | | | |
| | | μm SiC | | | |

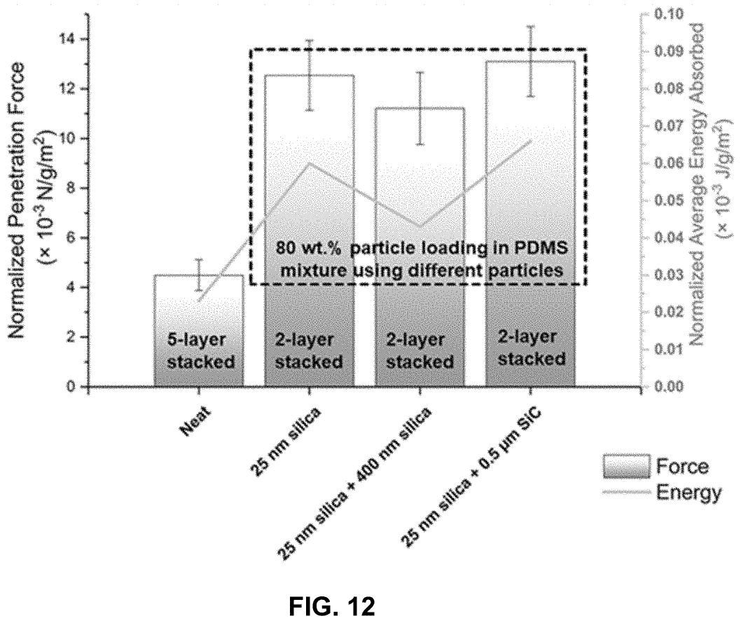

A comparison based on the areal density is shown by the histogram in FIG. 12 where a five-layer stack of neat fabric is compared to two-layer stack of treated fabric samples. The best performance was achieved with a two-layer stack of coated sample with 80 wt. % of particles in the PDMS mixture using a mixture of silica and SiC. This sample showed about 190 and 180% improvement in SPRF and SEA, respectively, compared with those of a five-layer neat fabric sample. Overall, a two-layer stack of coated fabric samples with 80 wt. % particles in the PDMS mixture has remarkably higher penetration resistance with considerably lower thickness and comparable flexibility which are crucial parameters in needle-puncture applications.

The effectiveness of using elastomeric composites reinforced with hard nanoparticle fillers to improve the penetration resistance of fabrics to hypodermic needles is demonstrated here. A novel technique is developed to disperse nano-sized fillers in PDMS using colloidal silica (CS) up to a loading of 80 wt. % particles in the elastomeric mixture using isopropanol (IPA) solvent. In addition, amorphous silica or silicon carbide powder was added to CS in order to improve the performance of the final products. Needle penetration tests were performed to determine the penetration resistance and energy dissipation of the treated fabric. Low concentration of silica particles dispersed in PDMS mixture was found to be not an effective solution to improve the specific penetration force (SPRF) and specific energy absorbed (SEA) of the neat fabric sample. There was a significant improvement in the penetration resistance of coated samples when the concentration of hard silica particles dispersed in the PDMS mixture was 65 wt. % and greater. This may be due to the onset of “elastic jamming” phenomenon or the formation of percolating network of connected particles at these percentages. The highest penetration resistance was obtained from a two-layer stack of coated sample with a mixture of 80 wt. % of “25 nm silica and 0.5 μm SiC” particles in PDMS. There was about 200% improvement in penetration resistance force compared to a five-layer stack of neat fabric (on the basis of equivalent areal density), while having similar flexibility and a thickness that was 40% less than the five-layer stack of neat fabric.

### EXAMPLE 2

In another example, penetration tests and characterization was performed for other exemplary composites.

Materials

The UHMWPE plain woven fabric (Spectra® 900) with an areal density of 230 g/m2, 1,200 denier, 1,333 dtex, and thread count of 21×21 yarns per inch was supplied by Barrday, Inc., Canada. The silicon carbide (SiC) particles from Panadyne Inc. Montgomeryville, USA had a nominal diameter of 0.5 μm and specific surface area of 4-8 m2/g. A polyurethane-based elastomer (Brush-On® 40 kit) was purchased from Smooth-On, Inc., Macungie, USA. The kit comprises of A and B components to be mixed in a 1:1 ratio by weight. An organic solvent (mineral spirit) was purchased from Recochem Inc., Canada.

Fabric Preparation—Plasma Treatment

UHMWPE fabric was cut to 12 cm×18 cm and then put in a capacitively coupled systems plasma chamber (PE-25, Plasma Etch, Inc.) with a radio frequency (RF) source at 50 kHz and vacuumed at around 18×10−2 Torr. Oxygen was then fed into the chamber (50 cc/min) for 60 sec during gas stabilization phase. The oxygen feed was then closed before the RF power is applied for 5 minutes with power of 300 W. The plasma treatment was found to increase the adhesion of UHMWPE to coating materials.

Coating Preparation

Organic solvent (mineral spirit) was added to the pre-polymer base part of Brush-On® 40 kit so the weight ratio of solvent to part-A (i.e., a cross-linking agent) is 3.5 and mixed thoroughly for 2 hr. SiC particles (0.5 μm in diameter) were then added to the mixture to 30 and 50 wt. % of the final mixture (i.e. the total weight of particles and parts-A&B of the polyurethane-based elastomer) and mixed for 3 hr. Paste-like part-B of the elastomer kit was then added to the well-dispersed mixture and stirred thoroughly for 30 minutes. At this point, the mixture has a low viscosity which makes it feasible for immersion (dip) coating process without additional equipment. The plasma-treated fabric samples were soaked (dipped) in the mixture for 15 seconds and hang-dried under a fume hood for five hours. Using this technique, the material pickup of fabric samples from a same coating mixture is fairly equivalent although the samples were not squeezed after the dip process. One general advantage of dip coating technique is that fibers are not stressed/distorted during such process.

Spike-Puncture and Needle-Penetration Tests

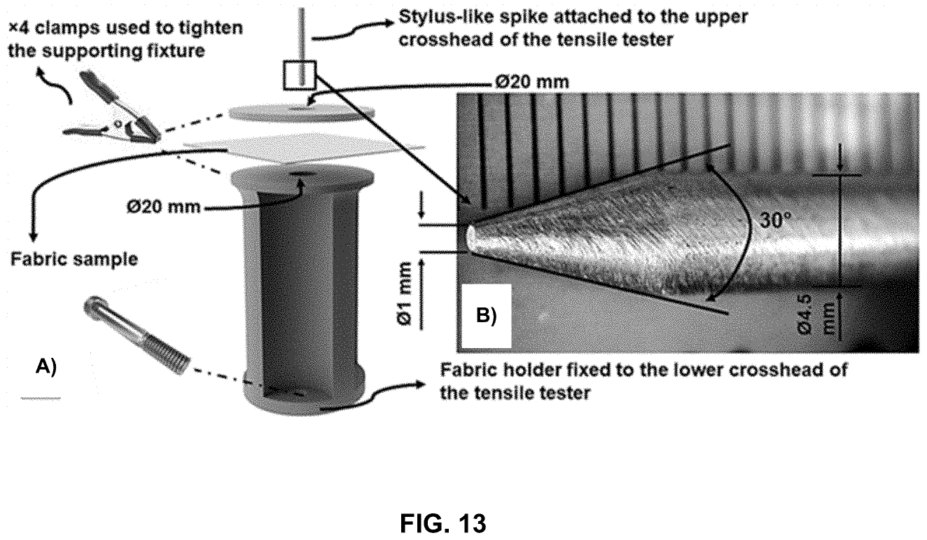

Spike-puncture penetration tests were performed according to EN 388:2015 “European Standard for Protective gloves against mechanical risks” protocols which is also suggested by American National Standard Institute/International Safety Equipment Association (ANSI/ISEA) 105-2016 standard. Using a SHIMADZU tensile tester with 500 N load cell, a steel stylus-like spike (FIG. 13b) with a diameter of 4.5 mm (nose diameter of 1 mm) was pushed through the fabric sample at a traverse speed of 100 mm/min. The supporting fixture for the fabric was made similar to EN 388:2015 with an open internal diameter of 20 mm (FIG. 13a). The fabric sample was held (sandwiched) firmly between the supporting fixture and another plate with the same open internal diameter of 20 mm using four clamps at the directions of warp and weft fibers.

Each test was repeated at least ten times on five similar samples to ensure consistency of the results and the maximum resistance force was recorded from force-vs-displacement curves. In a similar fashion, multiple-layer stacks of fabric were tested. Target samples were then categorized into different levels based on their penetration resistance according to ANSI/ISEA 105-2016 standards. ANSI/ISEA 105-2016 categorizes resistant textiles for hand protection based on their maximum resistance force against puncture (other than hypodermic needles) into five levels (Table A.1 in Appendix). Hypodermic needle penetration tests were performed similar to and in accordance with ASTM F2878—10 standards. Briefly, the fabric sample was held (sandwiched) firmly between the supporting fixture and another plate with the same open internal diameter of 20 mm. The fabric target was then punctured by the needles at a speed of 500 mm/min. A fresh 25 G 1″ (BD305125) hypodermic needlestick was used for each test and repeated at least ten times on five similar samples to ensure consistence of the results and the maximum resistance force was recorded from force-vs-displacement curves. Target samples were then categorized into different levels based on their penetration resistance according to ANSI/ISEA 105-2016 standards. ANSI/ISEA 105-2016 categorizes resistant textiles for hand protection based on their maximum resistance force against 25 G hypodermic needles into five levels (Table A.2 in Appendix).

Flexibility Test and Coefficient of Friction Determination

Flexibility tests were performed similar to our previous work based on the principles of ASTM D1388. The objective of this test is to compare the rigidity of 1-layer and multiple-layer target samples before and after coating. A 5 cm×10 cm piece of each sample was cut and encapsulated inside a thin polyethylene bag and a 20 g weight was attached to its leading edge at mid-point. With 6.2 cm length of the sample held firmly on the edge of table, its bending angle (BA) is then measured from captured images. Higher bending angle from this test means higher flexibility of the fabric sample. Static coefficient of friction of neat fabric (before and after plasma treatment) along weft direction were calculated according to ASTM D1894-14 using a SHIMADZU tensile tester with 500 N load cell (Method-C of apparatus for assembly).

Image Analysis and Contact-Angle Measurement

The images were taken using a handheld digital microscope (CELESTRON, LLC, California, USA). Scanning electron microscopy (SEM) analysis was done using a VEGA-LSU TESCAN VP. The SEM samples were coated with a thin gold layer to prevent charge build-up. Optical contact angle measurements were done using a DataPhysics OCA-35 instrument to analyze wettability of fabric surface before and after oxygen-plasma treatment. A drop of Milli-Q® ultrapure water (dosing rate of 2 μL/s) were applied using the instrument's electronic syringe unit on the surface of sample and the corresponding contact angle was recorded. Each test was repeated five times at different places of the fabric samples.

Results

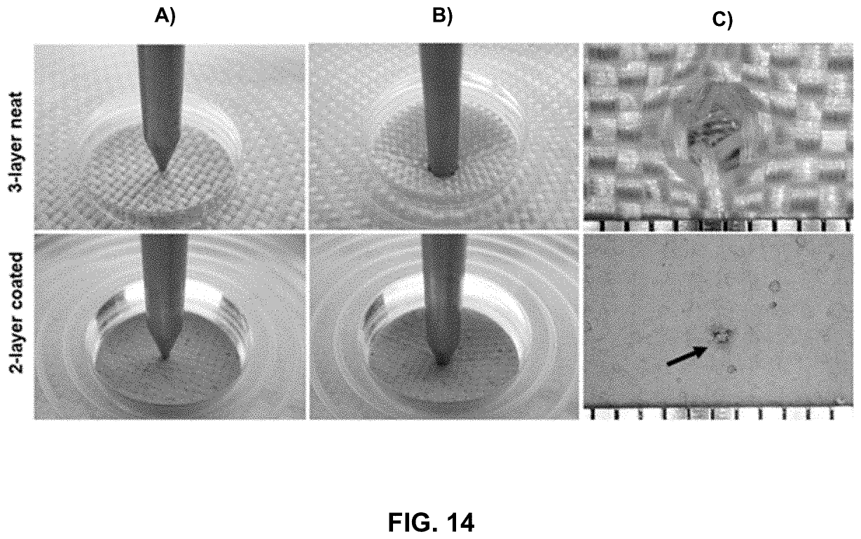

An initial spike penetration test was conducted on as-received and coated plasma-treated UHMWPE fabric samples to show the effectiveness of the coating process. The images of the samples before and after puncture under a maximum pre-set load of 100 N is shown in FIG. 14. The top row shows the spike penetration of a 3-layer stack of neat fabric and the bottom row shows the same penetration test on a 2-layer stack of plasma-treated coated fabric (with 50 wt. % of SiC nanoparticles in PU mixture) of a comparable areal density. It can be seen that the 3-layer neat fabric sample was easily penetrated, and fibers were pushed aside at the impact area. This is a typical “windowing mechanism” in textiles under the impact of a spike or similar sharp pointed-objects. On the contrary, the 2-layer stack of coated fabric sample was not penetrated and only a small dent was visible on the surface.

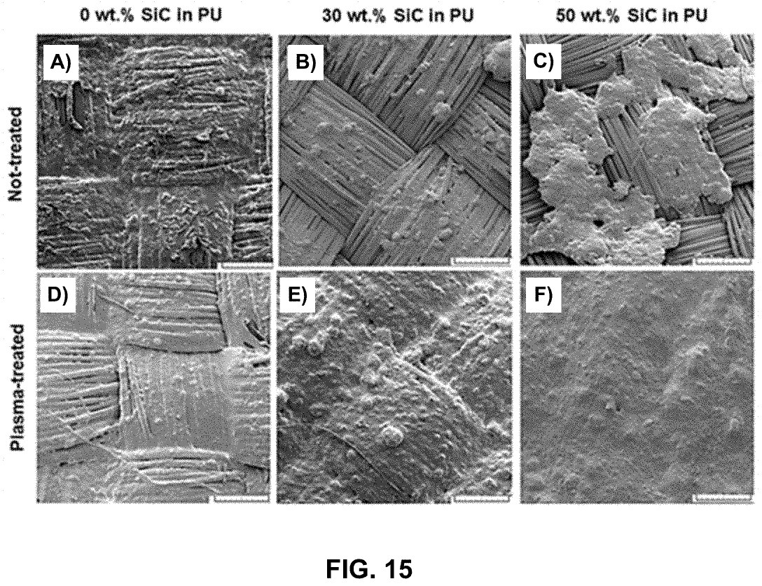

In order to understand the results better, the material was microscopically analyzed. The SEM images of untreated UHMWPE fabric with only PU coating are shown in FIG. 15a. It is seen from FIG. 15a that the coating material is not uniform and poorly bonded to the fabric substrate. Similar observations can be made for the coated UHMWPE fabric with 30 and 50 wt. % SiC in PU mixture from FIGS. 15b and 15c respectively. On the other hand, plasma-treated UHMWPE fabric with PU coating (FIG. 15d) showed improved coating uniformity. Similar improvement in uniformity of the coating material was also observed in particle-laden PU coatings (FIG. 15e to FIG. 15b and FIG. 15f to FIG. 15c). The areal density of coated samples increased by about 2-5% when the fabrics were plasma-treated and coated, which indicates a better wettability and higher absorption of the coating material onto fibers. Since plasma treatment has been used in the past to open reactive groups on textile surfaces to functionalize them, this behavior is expected. UHMWPE fiber with low surface energy and smooth surface is inherently inert and not a good host to bond with other materials. Through plasma treatment, polarizable groups can be introduced which will enhance wettability and also to bond to other matrix materials. For instance, plasma treatment has been used to improve adhesion between UHMWPE and high-density polyethylene (HDPE) matrices which resulted in higher interlaminar shear strength (ILSS), tensile, and impact strength of the fabricated composites. Similarly, plasma treatment of UHMWPE fiber also improves interfacial bonding with epoxy resin resulting higher tensile strength but considerably lower elongation.

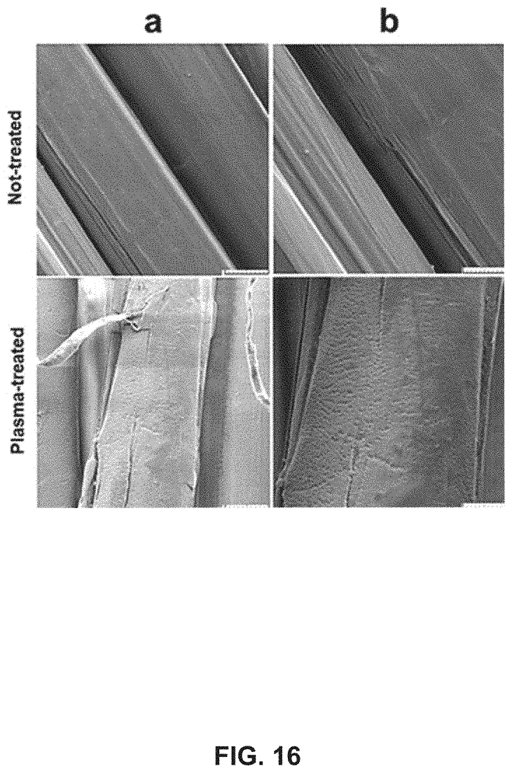

The water contact angle of as-received UHMWPE fabric was 120.7±3.6° which can be considered as a hydrophobic material. However, when a droplet of water was dropped on the surface of UHMWPE fabric which was treated with plasma for ⅙, ½, 1, 2, 3, 4, and 5 min, the water instantly spread over the surface of fabric indicating complete wetting of plasma-treated UHMWPE fabric. The change of contact angle confirms the remarkable change in surface properties from an inert material to one that has polarizable groups and open dangling bonds that could be beneficial for wettability and adhesion of coatings to the UHMWPE fabric (FIG. 15). In addition, the SEM images of UHMWPE fibers after plasma treatment reveals the presence of micro-pits onto the surface while as-received UHMWPE fiber appears perfectly smooth (FIG. 16). The presence of such micro-pits onto the surface of plasma-treated fibers could improve adhesion of UHMWPE fibers through mechanical interlocking mechanism. This observation is in agreement with the results for the coefficient of friction. The static coefficient of friction of UHMWPE fabric increased from 0.20±0.08 to 0.38±0.12 when it is plasma-treated for 5 min due to its higher roughness due to the presence of micro-pits.

Puncture Test Results

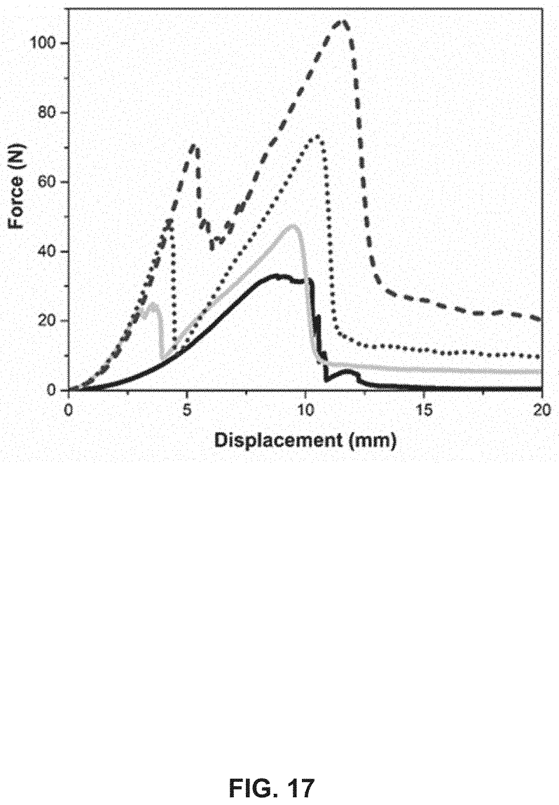

A single-layer neat plasma-treated UHMWPE fabric and single-layer samples of plasma-treated UHMWPE fabric coated with 0, 30, 50 wt. % concentration of SiC were tested to study the influence of the nanoparticle loading on puncture resistance against a spike threat. The typical force-displacement curves of 1-layer plasma-treated neat and coated plasma-treated UHMWPE fabric against spike penetration are shown in FIG. 17. The resistance force increases when the tip of the penetrator comes in contact with each of the samples. A first load peak occurs at about 3-6 mm of penetration distance in all three coated samples which matches the length of the conical tip of the spike shown in FIG. 13b. At the first peak, an audible burst sound was heard which is correlated to the breakage of adjacent fibres as the tip of spike pierced through the samples. The average resistance force of the coated plasma-treated UHMWPE fabric at the first peak load is 28.3±4.3, 55.3±8.2, and 67.3±6.8 N when the concentration of SiC in the PU mixture is 0, 30, and 50 wt. % respectively. This means that the resistance force of primary fibers in contact with the spike penetrator at the impact area increases when more SiC nanoparticles is added to the mixture of PU coating.

After the first peak, there is a sudden drop in the force in all three coated samples followed by an increase till the force reaches a second peak. The first peak and the sudden drop can be correlated to the point when the conical tip of the spike completely passed through the sample. The increase in the penetration force after the first peak can be attributed to the resistance from distant fibers near the impact zone. The average resistance force at the second peak-load (maximum resistance force) is 45.7±4.5, 67.3±8.3, and 105.7±9.3 N when the concentration of SiC in the PU mixture is 0, 30, and 50 wt. % respectively. The improvement in maximum resistance force as the concentration of SiC increased is because the fibers are more coupled with an increase in SiC and thus can exert more frictional force to the impactor. The load drops after the second peak as the conical tip of the spike completely penetrates through the fabric and adjacent fibers provide minimal further resistance. The plasma-treated neat UHMWPE fabric shows only a single peak of 33.2±8.7 N. In this case, unlike the coated fabric samples, the distant fibers do not exert a force to the spike penetrator when the failed fibers are pushed aside. This behavior can be attributed to the lower fiber-to-fiber and fiber-to-impactor frictional forces when the UHMWPE fabric was not coated.

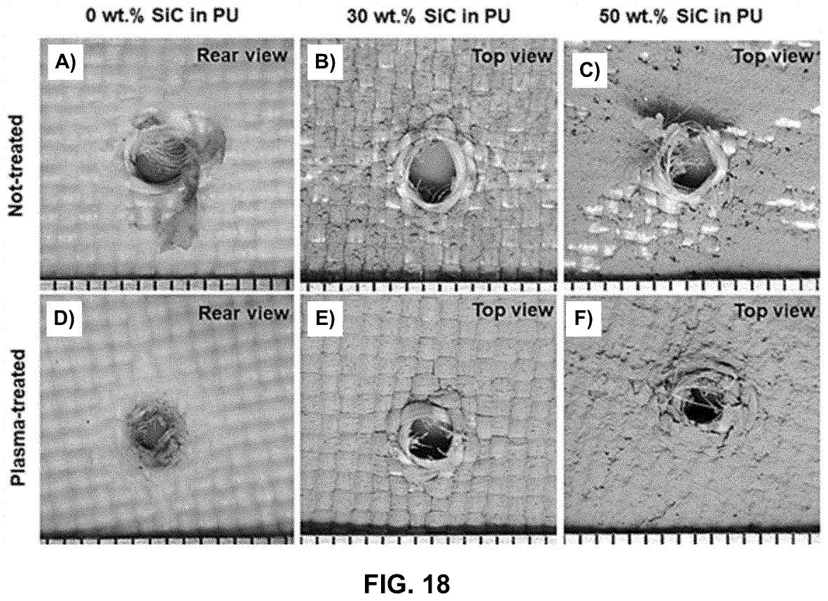

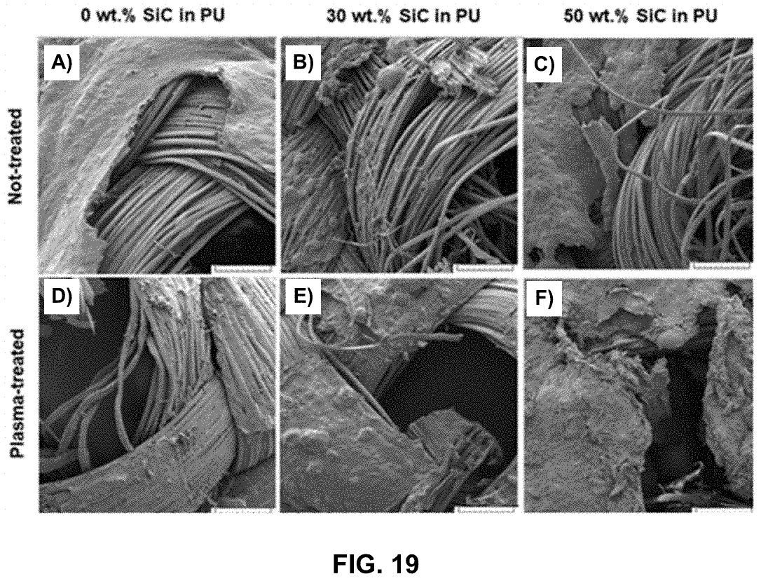

From the images of damage area on coated UHMWPE fabrics (FIG. 18), it was observed that all the three plasma-treated samples show a good coverage of the nanoparticle/elastomer material. On the contrary, the coating material is not uniform when the fabric is not plasma-treated prior to the coating process. A closer view of the damage zone is shown in FIG. 19. It can be clearly seen from FIG. 19a that the PU coating forms a shell on top of the untreated fabric while in FIG. 19d the PU is well integrated with the fibers of the fabric. Similar contrast is also observed between the untreated (FIGS. 19b and 19c) and the treated (FIGS. 19e and 19f) fabrics as the particle loading in the elastomer mixture is increased to 30 and then 50%. These results demonstrate that the plasma treatment plays a critical role in the penetration of the nanoparticle loaded PU onto the individual filaments as opposed to the untreated case where it forms a thin shell with poor bonding to the fibers. The integration of the nanoparticles into the depth of the fabric and between filaments is crucial in providing higher resistance to puncture. Furthermore, the coating material was found to be increasingly more damaged and peeled-off when the loading of SiC nanoparticles was increased from 0 to 50 wt. % of the PU mixture onto UHMWPE fabric without prior plasma treatment. From FIG. 19d to 19f, it can be seen that the effectiveness of plasma-treatment to improve adhesion and bonding strength of coating material to UHMWPE fabric is significant at all the loading concentrations of SiC nanoparticles in PU mixture. Overall, the extent of the damage is lesser for the plasma-treated fabric rather than the untreated one.

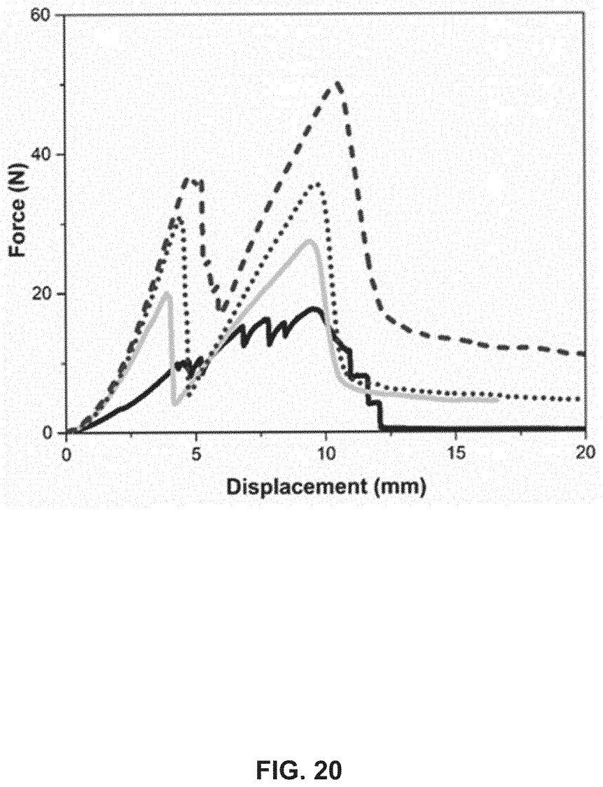

Additionally, FIG. 20 shows force-displacement curves from spike penetration tests of neat and coated UHMWPE fabric samples without prior oxygen-plasma treatment. Comparing these results with those in FIG. 17, it can be seen that plasma treatment increases the spike penetration resistance force of one-layer uncoated UHMWPE fabric. The impact of plasma treatment is also significant for the coated samples. The penetration resistance force of one-layer neat UHMWPE and coated UHMWPE fabric with 0, 30, and 50 wt. % SiC in PU decreased by about 35, 47, 51, and 54%, respectively, when the fabric is not plasma-treated.

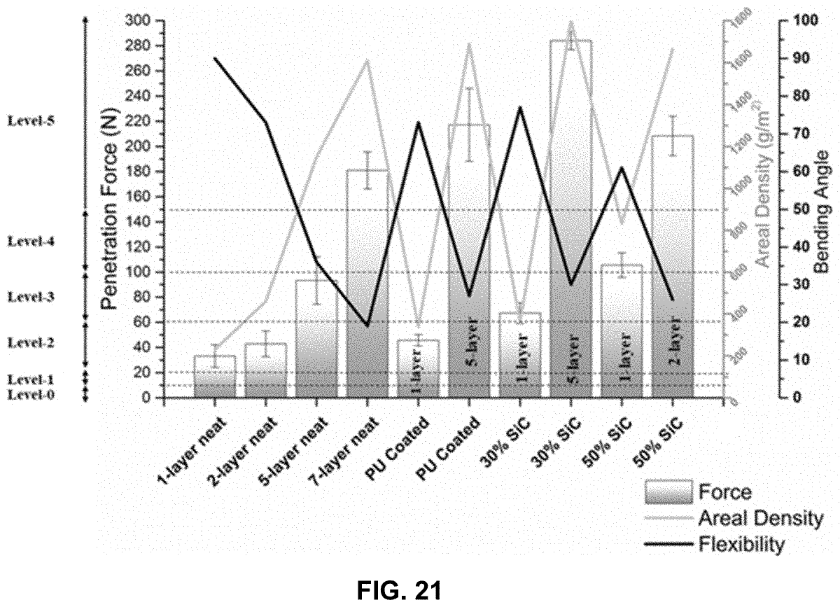

Multiple layers of neat and coated fabric samples were tested to investigate the effectiveness of the coating material based on areal densities, flexibility, and thickness. For this purpose, several layers of fabric samples were stacked together and tested against spike penetration. The histogram of maximum resistance force, areal density, and flexibility of plasma-treated neat and coated UHMWPE fabric samples of different stacked layers is presented in FIG. 21. Among all stacks of neat fabric, only the 7-layer stack of neat fabric could provide a Level-5 protection. The 7-layer stack of neat fabric has comparable areal density of the following stacked samples; (i) 5-layer coated fabric with PU, (ii) 5-layer coated fabric with 30 wt. % SiC in PU, and (iii) 2-layer coated fabric with 50 wt. % SiC in PU. The maximum resistance force of these stacked samples was found to be about 20, 57, and 15% more, respectively, as compared with the resistance of a 7-layer neat fabric. Interestingly, the 5-layer coated fabric with 30 wt. % of SiC in PU showed about 36% higher penetration force compared with 2-layer coated fabric with 50 wt. % SiC in PU (of comparable areal density), although one layer of the coated fabric with 50 wt. % SiC in PU mixture showed the highest maximum penetration resistance among all the samples. This result indicates that the number of stacked layers also play a major role in increasing the penetration resistance of target samples in addition to the loading of particles in the PU mixture.

Also, from Table 1, the average thickness of 7-layer stack of neat fabric reduced by about 21-55% compared to 2-layer and 5-layer of coated samples of comparable areal density. From Table 1, 1-layer neat fabric has the lowest rigidity while 1-layer coated fabric with 50 wt. % SiC in PU mixture has the highest. Comparing the flexibility of multi-layer stacks of fabric samples with comparable areal density, it was found that the 7-layer stack of neat fabric was less flexible than 5-layer stack of coated samples with 0 and 30 wt. % of SiC in PU mixture and even the 2-layer stack of coated fabric with 50 wt. % SiC in PU mixture.

Apart from areal density, flexibility and thinness are equally important factors in the manufacture of protective gloves. Therefore, a figure of merit was formulated that represents the ratio of percentage increase in penetration resistance to percentage increase in thickness of different multi-layer neat and coated samples over a single layer of neat UHMWPE fabric and can be used to evaluate the performance of the various compositions and combinations that were fabricated. This figure of merit was found to be 0.74, 1.35, 1.68, and 2.49, respectively, for 7-layer neat, 5-layer coated with PU, 5-layer coated with 30 wt. % SiC, and 2-layer coated with 50 wt. % SiC. They show that addition of SiC nanoparticles increase the penetration resistance significantly more as compared with any increases in thickness of the overall coated fabric. Hence, the coated sample with 50 wt. % SiC in PU mixture provides the optimal performance, which is Level-5 resistance, acceptable thickness and flexibility among all the samples.

TABLE 2
Areal density, thickness, and bending angle of plasma-
treated neat and coated UHMWEPE fabric samples.

| No. of | Particle loading | | | Bending |
|---|---|---|---|---|
| stacked | in PU mixture | Areal Density | Thickness | Angle |
| fabric layers | (wt. %) | (g/m²) | (mm) | (θ ± 2°) |
| 1 | Neat (no coating) | 230 ± 11 | 0.5 | 90 |
| | 0 (only PU) | 338 ± 16 | 0.51 ± 0.01 | 73 |
| | 30 | 360 ± 22 | 0.55 ± 0.01 | 77 |
| | 50 | 832 ± 59 | 0.78 ± 0.09 | 61 |
| 7 | Neat (no coating) | ~1610 | 3.5 | 19 |
| 5 | 0 (only PU) | ~1690 | ~2.55 | 27 |
| | 30 | ~1800 | ~2.75 | 30 |
| 2 | 50 | ~1664 | ~1.56 | 26 |

Hypodermic Needlestick Penetration

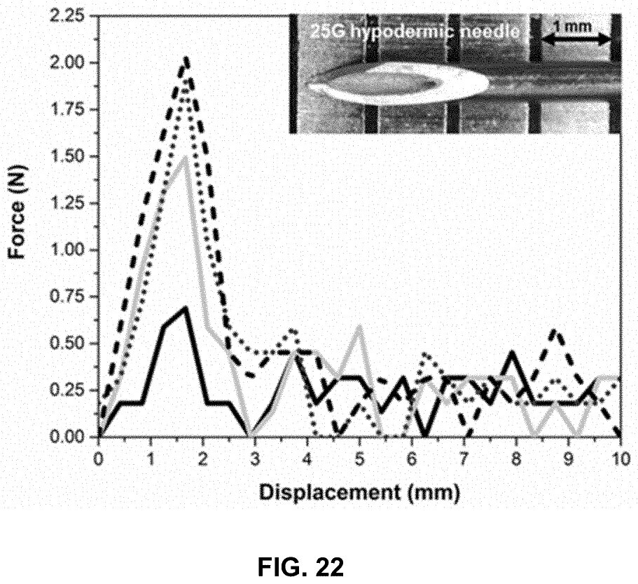

Single and multiple layers of neat and coated fabric samples of plasma-treated UHMWPE fabric were tested to study the impact of coating (0, 30, and 50 wt. % concentration of SiC) on penetration resistance against a needlestick threat. The typical force-displacement curves of 1-layer plasma-treated neat and coated plasma-treated UHMWPE fabric against needlestick penetration are shown in FIG. 22. The measured resistance force increases as the tip of needle comes in contact with the fabric samples. The maximum resistance force was detected at about 1-2 mm after the tip of needle penetrates through the coated fabric samples which matches the sharp-cutting continuous edge of the needle (2 mm). A peak force represents the maximum resistance of textile samples against penetration of hypodermic needle by spreading the fibers away by the tip (windowing mechanism) and cutting the fibers by the sharp conical part (cutting mechanism). The load drops afterwards with minimal resistance against the penetrator. Unlike load-displacement curves shown for the spike test, a second peak was not detected from needle penetration test. This was attributed to the lack of resistance of distant fibers neat the point of impact due to the small size of needle compared with the spike penetrator.

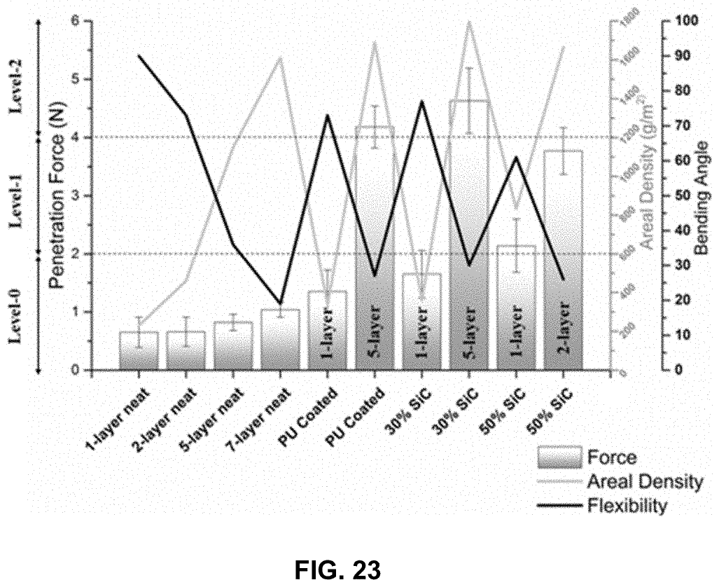

Maximum resistance force, bending angle, and areal density histogram plots of 1-layer and multiple-layer neat and coated fabric samples are presented in FIG. 23. It is observed that the resistance force of 1-layer neat fabric (0.65±0.26 N) does not change significantly compared to 2-, 5-, and 7-layer neat samples and even a 7-layer stack of neat fabric is still Level-0 resistance. Coating a 1-layer fabric with 0, 30, and 50 wt. % SiC in PU mixture increases average penetration resistance by about 108, 154, and 229% (respectively). Among the coated samples, only 1-layer coated fabric with 50 wt. % SiC in PU is considered as a Level-1 protection. Multiple layers of neat and coated samples were tested to investigate the effectiveness of the coating material based on areal densities, flexibility, and thickness. For this purpose, several layers of fabric samples of comparable areal densities were stacked together and tested against needlestick penetration. The penetration resistance force of a 7-layer neat UHMWPE (1.04±0.13 N) increased by about 302, 340, and 262% compared to 5-layer coated fabric with PU, 5-layer coated fabric with 30 wt. % of SiC in PU mixture, and 2-layer coated fabric with 50 wt. % of SiC in PU mixture, respectively. The highest resistance is level-2 for the 5-layer coated fabric with PU and also 5-layer coated fabric with 30 wt. % of SiC in PU mixture. It was observed that adding SiC in PU coating does not improve the hypodermic needlestick penetration resistance-level of coated fabric significantly and is not a promising solution for this type of threat. In general, the impact of nanoparticles in elastomeric mixture to improve penetration resistance of textiles against hypodermic needle becomes significant only at a very high particle loading of 65 wt. % or higher, which triggers “elastic jamming” mechanism.

Here, this example shows the impact of coating UHMWPE fabric with a mixture of SiC and polyurethane (PU) to provide spike and hypodermic penetration resistance. A dip coating process to incorporate nanoparticle-elastomer mixtures with up to 50 wt. % particle loading was demonstrated. Spike puncture tests performed on coated fabric show a significantly higher resistance than neat fabric and the resistance increased with increase in SiC content. The penetration resistance of coated fabric was significantly higher than the neat fabric even when different stacks of target samples of comparable areal density were compared. A 5-layer stack of coated fabric with a mixture of 30 wt. % SiC in PU showed about 57% higher resistance and better flexibility compared to a 7-layer stack of neat fabric of the comparable areal density with 21-55% less thickness. The higher resistance of coated samples can be attributed to a combination of penetration of the coating into the fabric, better adhesion coating material with the fibers and the effect of the loaded nanoparticles in exerting more frictional force to the impactor. We also showed that plasma-treatment is a crucial preparation process for UHMWPE fabric to improve the adhesion and integration of coating material to the fabric. Non-uniform coatings and poor penetration and puncture resistances were obtained without plasma treatment. Similarly, the resistance of coated fabrics against hypodermic needle was superior to the neat fabric. The combination of SiC nanoparticles with PU elastomer provides an interesting solution in increase the puncture resistance while not affecting the needle penetration significantly. In the future, this property could be used in ballistic textiles (such as UHMWPE) which have rather weak resistance against puncture threats in order to improve their robustness and all-round performance.

While the above description provides examples of one or more methods or systems, it will be appreciated that other methods or systems may be within the scope of the claims as interpreted by one of skill in the art.

### REFERENCES

E. D. Wetzel, N. J. Wagner, Stab resistance of shear thickening fluid (STF)-kevlar composites for body armor applications, in Proceedings of the International Conference on Safety and Protective Fabrics, Orlando, Fla., 2 Dec. 2004.
R. G. Egres Jr., Y. S. Lee, J. E. Kirkwood, K. M. Kirkwood, E. D. Wetzel, N. J. Wagner, Liquid armor: Protective fabrics utilizing shear thickening fluids, in Proceedings of the International Conference on Safety and Protective Fabrics, Pittsburgh, Pa., 26-27 Oct. 2004.
M. J. Decker, C. J. Halbach, C. H. Nam, N. J. Wagner, E. D. Wetzel, Stab resistance of shear thickening fluid (STF)-treated fabrics, Composites Sci. Technol. 67 (2007) 565-578.
J. B. Mayo Jr., E. D. Wetzel, M. V. Hosur, S. Jeelani, Stab and puncture characterization of thermoplastic-impregnated aramid fabrics, Int. J. Impact Eng. 36 (2009) 1095-1105.
J. M. Houghton, B. A. Schiffman, D. P. Kalman, E. D. Wetzel, N. J. Wagner, Hypodermic needle puncture of shear thickening fluid (STF)-treated fabrics,” in Proceedings of SAMPE, Baltimore, Md., 3-7 Jun. 2007.
D. P. Kalman, R. L. Merrill, N. J. Wagner, E. D. Wetzel, Effect of particle hardness on the penetration behavior of fabrics intercalated with dry particles and concentrated particle-fluid suspensions, ASC Appl. Mater. Interfaces 1 (2009) 2602-2612.
B. A. Cheeseman, T. A. Bogetti, Ballistic Impact Into Fabric and Compliant Composite Laminates, Compos. Struct. 61 (2003) 161-173.
J. L. Park, B. II Yoon, J. G. Paik, T. J. Kang, Ballistic performance of p-aramid fabrics impregnated with shear thickening fluid; Part I—Effect of laminating sequence, Text. Res. J. 82 (201) 527-541.
J. L. Park, B. II Yoon, J. G. Paik, T. J. Kang, Ballistic performance of p-aramid fabrics impregnated with shear thickening fluid; Part II—Effect of fabric count and shot location, Text. Res. J. 82 (2012) 542-557.
S. Das, S. Jagan, A. Shaw, A. Pal, Determination of inter-yarn friction and its effect on ballistic response of para-aramid woven fabric under low velocity impact, Comos. Struct. 120 (2015) 29-140.
A. Majumdar, B. S. Butola, A. Srivastava, Development of soft composite materials with improved impact resistance using kevlar fabric and nano-silica based shear thickening fluid, Mater. Des. 54 (2014) 295-300.
Y. S. Lee, E. D. Wetzel, N. J. Wagner, The ballistic impact characteristics of kevlar® woven fabrics impregnated with a colloidal shear thickening fluid, J. Mater. Sci. 38 (2003) 2825-2833.
V. B. C. Tan, T. E. Tay, W. K. Teo, Strengthening fabric armour with silica colloidal suspensions, Int. J. Solids. Struct. 42 (2005) 1561-1576.
A. Srivastana, A. Majumdar, B. S. Butola, Improving the impact resistance performance of kevlar fabrics using silica based shear thickening fluid, Mat. Sci. Eng. A. 529 (2011) 224-229.
A. Majumdar, B. S. Butola, A. Srivastava, An analysis of deformation and energy absorption modes of shear thickening fluid treated kevlar fabrics as soft body armour materials, Mater. Des. 51 (2013) 148-153.
R. Gadow, K. von Niessem, Lightweight ballistic structures made of ceramic and cermet/aramid composites, Ceram. Trans. 151, p 3-18, Ceramic Armor and Armor Systems, Proceedings; Conference: Ceramic Armor and Armor Systems, Proceedings, Apr. 27, 2003-Apr. 30, 2003.
D. Firouzi, D. A. Foucher, H. Bougherara, Nylon-coated ultra high molecular weight polyethylene fabrics for enhanced penetration resistance, J. Appl. Sci. 131 (2014) 40350.
D. Firouzi, A. Youssef, M. Amer, R. Srouji, A. Amleh, D. A. Foucher, H. Bougherara, A new technique to improve the mechanical and biological performance of ultra high molecular weight polyethylene using a nylon coating, J. Mech. Behav. Biomed. Mater. 32 (2014) 198-209.
S. Kim, C. F. Richardson, Y. K. Kim, S. Lee, “Protective material having guard plates on clearly visible substrate”. U.S. Pat. No. 0,206,526 A1, 28 Aug. 2008.
Y. H. Kim, N. Smith, H. Ji, “Penetration resistance fabric with multiple layer guard plate assemblies and method of making the same”. U.S. Pat. No. 7,018,692 B2, 28 Mar. 2006.
L. E. Gates Jr. Evaluation and development of fluid armor systems, Air Force Materials Laboratory AFML-TR-68-362, (1968).
H. Mahfuz, F. Clements, V. Rangari, V. Dhanak, G. Beason, Enhanced stab resistance of armor composites with functionalized silica nanoparticles, J. Appl. Phys. 105 (2009) 064307.
Y. Xu, X. Chen, Y. Wang, Z. Yuan, Stabbing resistance of body armour panels impregnated with shear thickening fluid, Compos. Struct. 163 (2017) 465-473.
N. Wagner, E. D. Wetzel, “Advanced body armor utilizing shear thickening fluids”. U.S. Pat. No. 7,498,276 B2, 3 Mar. 2009.
H. M. Rao, M. V. Hosur, S. Jeelani, 12—Stab characterization of STF and thermoplastic-impregnated ballistic fabric composites, in: Advanced fibrous composite materials for ballistic protection, edited by X. Chen, Woodhead Publishing, 2016, pp. 363-387.
R. J. Rabb and E. P. Fahrenthold, Evaluation of shear-thickening-fluid kevlar for large-fragment containment applications, J. Aircr. 48 (2011) 230-234.
B. W. Lee and II-J. Kim, C. G. Kim, The influence of the particle size of silica on the ballistic performance of fabrics impregnated with silica colloidal suspensions, J. Compos. Mater. 43 (2009) 2679-2698.
N. Wagner, J. Brady, Shear thickening in colloidal dispersions,” Phys. Today 62 (2009) 27-32.
D. Sumi, A. Dhanabalan, B. H. S. Thimmappa, S. Krishnamurthy, Effect of colloidal silica dispersions on the properties of PDMS-colloidal silica composites, J. Appl. Polym. Sci. 125 (2012) E515-E522.
S. Dinkar, A. Dhanabalan, Preparation and properties of poly(dimethyl siloxane)-colloidal silica/functionalized colloidal silica nanocomposites, J. Appl. Polym. Sci. 126 (2012) 1585-1592.
O. E. Petel, S. Ouellet, B. J. Marr, A. J. Higgins and D. L. Frost, Ballistic penetration of particle-laden elastomers, in 27th international symposium on ballistics, Freiburg, Germany, 22-26 Apr. 2013.
S. H. Amiri Afeshejani, S. A. R. Sabet, M. E. Zeynali, M. Atai, Energy Absorption in a Shear-Thickening Fluid, J. Mater. Eng. Perform. 23 (2014) 4289-4297.
T. H. Hassa, V. K. rangari, S. Jeelani, Synthesis, processing and characterization of shear thickening fluid (STF), Mater. Sci. Eng. A 527 (2010) 2892-2899.
Z. Gong, Y. Xu, W. Zhu S. Xuan, W. Jiang, W. Jiang, Study of the knife stab and puncture resistant performance of shear thickening fluid enhanced fabric, J. Compos. Mater. 48 (2013) 641-657.
S. Richter, H. Kreyenschulte, M. Saphiannikova, T. Gotze, G. Heinrich, Studies of the so-called jamming phenomenon in filled rubbers using dynamical-mechanical experiments, Macromol. Symp. 306-307 (2011) 141-149.
X. Wang, C. G. Robertson, Strain-induced nonlinearity of filled rubbers, Phys. Rev. E 72 (2005) 031406.
I. R. Peters, S. Majumdar, H. M. Jaeger, Direct observation of dynamic shear jamming in dense suspensions, Nature 532 (2016) 214-217.
A. Cotter, “Firearms and violent crime in Canada”, Statistics Canada https://www150.statcan.gc.ca/n1/pub/85-005-x/2018001/article/54980-eng.htm, 2018.
F. Cecchini; V. Cherubini; M. Sadaf; F. Fabbrocino; F. Nanni, Design of a puncture-resistant composite shell comprising a non-Newtonian core, Polym. Test., 67 (2018) 494-502.
D. Firouzi; D. A. Foucher; H. Bougherara, Nylon-Coated Ultra High Molecular Weight Polyethylene Fabric for Enhanced Penetration Resistance, J. Appl. Polym. Sci., 131 (2014) 40350.
D. Firouzi; M. K. Russel; S. N. Rizvi; C. Y. Ching; P. R. Selvaganapathy, Development of flexible particle-laden elastomeric textiles with improved penetration resistance to hypodermic needles, Mater. Des., 156 (2018) 419-428.
M. J. Decker; C. J. Halbach; C. H. Nam; N. J. Wagner; E. D. Wetzel, Stab resistance of shear thickening fluid (STF)-treated fabrics, Compos. Sci. Technol., 67 (2007) 565-578.
B. A. Cheeseman; T. A. Bohetti, Ballistic Impact Into Fabric and Compliant Composite Laminates, Compos. Struct., 61 (2003) 161-173.
J. Park; B. Yoon; J. Paik; T. Kang, Ballistic Performance of p-Aramid Fabrics Impregnated with Shear Thickening Fluid; Part I—Effect of Laminating Sequence, Text. Res. J., 82 (2012) 527-541.
J. Park; B. Yoon, J. Paik; T. Kang, Ballistic Performance of p-Aramid Fabrics Impregnated with Shear Thickening Fluid; Part II—Effect of Fabric Count and Shot Location, Text. Res. J., 822012) 542-557.
S. Das; S. Jagan; A. Shaw; A. Pal, Determination of inter-yarn friction and its effect on ballistic response of para-aramid woven fabric under low velocity impact, Compos. Stuct., 120 (2015) 129-140.
R. A. Lane, High performance fibers for personnel and vehicle armor systems, The AMPTIAC Quarterly, Volume 9, Number 2, 2005.
Y. S. Lee; N. J. W. E. D. Wetzel, The ballistic impact characteristics of Kevlar woven fabrics impregnated with a colloidal shear thickening fluid, J. Mat. Sci., 38 (2003) 2825-2833.
V. B. C. Tan; T. E. Tay; W. K. Teo, Strengthening fabric armour with silica colloidal suspensions, Int. Solids. Struct., 42 (2005) 1561-1576.
S. M. Kurtz, Chapter 17—Composite UHMWPE Biomaterials and Fibres, in UHMWPE Biomaterials Handbook (2nd Edition), Academic Press, 2009, pp. 249-258.
S. Liu; J. Wang; Y. Wang; Y. Wang, improving the ballistic performance of ultra high molecular weight polyethylene fiber reinforced composites using conch particles, Mater. Des., 31 (2010) 1711-1715.
S. P. Lin; J. L. Han; J. T. Yeh; F. C. Chang; K. H. Hsieh, Surface modification and physical properties of various UHMWPE-fiber-reinforced modified epoxy composites,” J. Appl. Polym. Sci., 104 (2007) 655-665.
C. S. Li; X. C. Huang; Y. Li; N. Yang; Z. Shen; X. H. Fan, Stab resistance of UHMWPE fiber composites impregnated with thermoplastics, Polym. Adv. Technol., 25 (2014) 1014-1019.
L. L. Sun; D. S. Xiong; C. Y. Xu, Application of shear thickening fluid in ultra high molecular weight polyethylene fabric, J. Appl. Polym. Sci. 129 (2013) 1922-1928.
W. Li; D. Xiong; X. Zhao; L. Sun; J. Liu, Dynamic stab resistance of ultra-high molecular weight polyethylene fabric impregnated with shear thickening fluid, Mater. Des., 102 (2016) 162-167.
N. Asija; H. Chouhan; S. A. Gebremeskel; R. K. Singh; N. Bhatnagar, High strain rate behavior of STF-treated UHMWPE composites, Int. J. Impact Eng., 110 (2017) 359-364.
Y. Park, Y. H. Kim; A. H. Baluch; C. G. Kim, Empirical study of the high velocity impact energy absorption characteristics of shear thickening fluid (STF) impregnated Kevlar fabric, Int. J. Imp. Eng., 72 (2017) 67-74.
M. Fahool; A. R. Sabet, Parametric study of energy absorption mechanism in Twaron fabric impregnated with a shear thickening fluid, Int. J. Impact. Eng., 90 (2016) 61-71.
O. E. Petel; A. J. Higgins, Shock wave propagation in dense particle suspensions, J. App. Phys., 108 (2010) 114918.
O. E. Petel; D. L. Frost; A. J. Higgins, Formation of a disordered solid via a shock-induced transition in a dense particle suspension,” Phys. Rev. E, 85 (2012) 021401.
N. Wagner, E. D. Wetzel, “Advanced body armor utilizing shear thickening fluids”. U.S. Pat. No. 7,498,276 B2, 3 Mar. 2009.
H. M. Rao; M. V. Hosur; S. Jeelani, Chapter 12—Stab characterization of STF and thermoplastic-impregnated ballistic fabric composites, in Advanced fibrous composite materials for ballistic protection, Edited by X. Chen, Woodhead Publishing, 2016, pp. 363-387.
D. Firouzi; A. Youssef; M. Amer; R. Srouji; A. Amleh; D. A. Foucher; H. Bougherara, A new technique to improve the mechanical and biological performance of ultra high molecular weight polyethylene using a nylon coating, J. Mech. Behav. Biomed. Mater, 32 (2014) 108-209.
R. Roy; A. Laha; N. Awasthi; A. Majumdar; B. S. Butola, Multi layered natural rubber coated woven P-aramid and UHMWPE fabric composites for soft body armor application, Polym. Compos., (2017) 1-9.
S. Kanesalingam; R. Nayak; L. Wang; R. Padhye; L. Arnold, Stab and puncture resistance of silica-coated Kevlar-wool and Kevlar-wool-nylon fabrics in quasistatic conditions, Text. Res. J., (2018) 1-17.
M. Joshi; B. S. Butola, Application technologies for coating, lamination and finishing of technical textiles, In Advances in Dyeing and Finishing of Technical Textiles, Cambridge: Woodhead Publishing Ltd, 2013, pp. 355-411.
R. He; F. Niu; Q. Chang, The effect of plasma treatment on the mechanical behavior of UHMWPE fiber-reinforced thermoplastic HDPE composite, Surf. Interface Anal. 50 (2017) 73-77.
S. I. Moon; J. Jang, The effect of the oxygen-plasma treatment of UHMWPE fiber on the transverse properties of UHMWPE-fiber/vinyl ester composites, Compos. Sci. Technol. 59 (1999) 487-493.
J. M. Houghton; B. A. Schiffman; D. P. Kalman; E. D. Wetzel; N. J. Wagner, Hypodermic needle puncture of shear thickening fluid (STF)-treated fabrics,” in Proceedings of SAMPE, Baltimore, Md., 3-7 Jun. 2007.

What is claimed is:

1. A penetration-resistant composite comprising:
a woven or non-woven substrate; and
an elastomeric binder covering at least a portion of the substrate, the elastomeric binder including:
a polymeric base; and
particles dispersed within the polymeric base, the particles including one or more of amorphous silica particles, fumed silica particles, boron nitride particles, calcium chloride particles, aluminum oxide particles, calcium carbonate particles, graphite particles, metallic glass particles and silicon carbide particles, the particles having a concentration in a range of about 0 wt. % to about 80 wt. % of the elastomeric binder and being of a size in a range of about 1 nanometers to 100 micrometers.

2. The penetration-resistant composite of claim 1, wherein the particles have a concentration in a range of about 50 wt. % to about 80 wt. % of the elastomeric binder.

3. The penetration-resistant composite of claim 2, wherein the particle concentration is higher than a critical limit to cause jamming of the particles within the elastomeric binder when the composite is compressed.

4. The penetration-resistant composite of claim 1, wherein the polymeric base is selected from a class of chemicals including silicones, thermoplastic elastomers, natural or synthetic rubbers, fluoro or perfluoro elastomers and elastoolefins.

5. The penetration-resistant composite of claim 1, wherein the polymeric base comprises one or more of polydimethylsiloxane (PDMS), thermoplastic polyurethane (TPU), styrenic block copolymers (TPS), poly isoprene, butyl rubber, nitrile rubber and fluorosilicone rubber.

6. The penetration-resistant composite of claim 1, wherein the particles include one or more of silica (SiO₂) and/or silicon carbide (SiC) particles.

7. The penetration-resistant composite of claim 1, wherein the particles are spherical, oval, elongated or sheet like.

8. The penetration-resistant composite of claim 1, wherein the substrate and the elastomeric binder form one layer of a plurality of layers of the composite.

9. The penetration-resistant composite of claim 1, wherein the substrate is woven, non-woven, or 0°/90° cross-plied of continuous fibres of aramid, nylon polypropylene, polyethylene, S-Glass, or polybenzobisoxazole (PBO), polyester, or cotton fibers.

10. A method of forming a penetration-resistant composite, the method comprising:
mixing particles with a pre-polymer of an elastomeric binder to form a pre-polymer mixture, the particles including one or more of amorphous silica particles, fumed silica particles, boron nitride particles, calcium chloride particles, aluminum oxide particles, calcium carbonate particles, graphite particles, metallic glass particles or silicon carbide particles, each of the particles having a having a diameter in a range of about 10 nanometers to 50 micrometers;
infusing the prepolymer mixture into a substrate; and
curing the infused substrate using heat, air-drying or optical means to form the penetration-resistant composite.

11. The method of claim 10, wherein mixing the particles into the pre-polymer of the elastomeric binder includes mixing a colloidal silica with the particles and the elastomeric binder.

12. The method of claim 10, wherein the elastomeric binder includes PDMS and the particles have a concentration in a range of about 0 to about 80 wt. % of the elastomeric binder.

13. The method of claim 10, wherein mixing the particles with the pre-polymer of the elastomeric binder includes mixing an alcohol solvent with the pre-polymer mixture.

14. The method of claim 13, wherein the solvent is selected from a group of lower alkanols including methanol, ethanol, propanol, butanol and cyclohexanol.

15. The method of claim 10, wherein, prior to mixing the particles with the elastomeric binder, the particles are mixed with a colloidal silica and treated with an alcohol solvent to form a particle mixture, and the particle mixture is mixed with the pre-polymer of the elastomeric binder.

16. The method of claim 10 further comprising, prior to infusing the prepolymer mixture in the substrate, performing a plasma treatment to the substrate.

17. The method of claim 10, wherein infusing the prepolymer mixture into the substrate includes soaking the substrate in the prepolymer mixture for about one minute.

18. The method of claim 17, wherein infusing the prepolymer mixture into the substrate further includes, after soaking the substrate in the prepolymer mixture, passing the substrate through a manual cold laminator to remove excess prepolymer mixture from the substrate.

19. An article comprising the penetration-resistant composite of claim 1.

20. The article of claim 19, wherein the article is a security vest, body armor, or blast proof shields.
